(19) United States
(12) Patent Application Publication
(10) Pub. No.: US 2008/0294565 A1
(43) Pub. Date: Nov. 27, 2008

(54) Basis Instrument Contracts (BICs) derived methods, systems and computer program products for distributional linkage and efficient derivatives pricing

(76) Inventor: Phil Kongtcheu, (US)

Correspondence Address: PHIL KONGTCHEU;PFK TECHNOLOGIES, 37 CEDAR STREET, JERSEY CITY, NJ, 07305, US

(21) Appl. No.: 11/539,627

(22) Filed: Oct. 7, 2006

(51) Int. Cl. G06Q 40/00

(52) U.S. Cl. 705/36 R

(57) ABSTRACT

The present invention describes methods, systems and computer program products derived from the BICs structural framework and pricing methodology to facilitate at least two types of intermediate decision-making problems:
(i) Methods, systems and computer program products that help generate the distributional relationship between two or more real number physical observable(s) a.k.a underlying(s) with flexibility and logical coherence. The underlying(s), outcomes/actual numeric realizations at one or more future time periods may be unknown at a time of consideration but the distributions of outcomes exist for each individual underlying and/or for each couple of underlyings. This invention uses a Basis Instrument Contract pricing and representation format to generate the multivariate distribution of all the underlyings knowing only the univariate or bivariate distributions. The availability of such a coherently generated
(ii) Methods that help generate the price of various derivatives contracts using BICs in efficient analytical formulas or very fast numerical methods. This is particularly the case when the underlyings are driven by Levy processes or with readily available characteristic functions. The systems and computer program products that use these methods are thus faster and more flexible with respect to the variety of derivatives contract payouts that can be seamlessly priced as well as the possible assumptions on the distributions of the underlyings.

### BACKGROUND OF THE INVENTION

The background of the present invention is laid out in detail in the book BICs 4 Derivatives Volume I: Theory and in PCT international application publication no. WO03107137 hereby incorporated by reference. Unless otherwise indicated, definitions, notations, chapters, sections references or other parts not internally described are by default those of the book BICs 4 Derivatives Volume I: Theory

### BRIEF DESCRIPTION OF THE SEVERAL VIEWS OF THE DRAWINGS

FIG. 1. illustrates the correspondence between implied density function and implied volatility function as described in Part A of the Detailed Description.

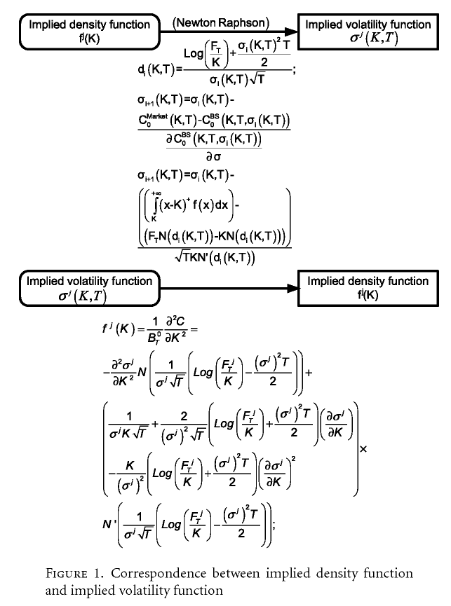

FIG. 2. illustrates the correspondence between implied bivariate density function and implied correlation function as described in Part A of the Detailed Description.

FIG. 3. illustrates the correspondence between implied multivariate joint density and implied correlation matrix function, implied volatility vector function as described in Part A of the Detailed Description.

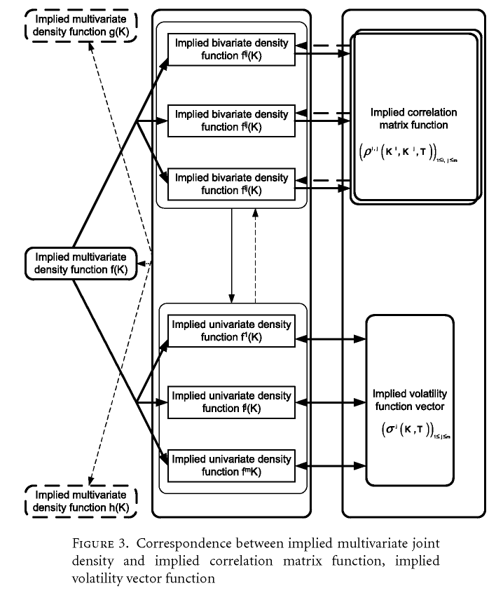

### DETAILED DESCRIPTION

This detailed description is subdivided in two parts. Part A is titled The Options BICs Format and Distributional Linkage—An Alternative to Copulas and is essentially chapter IX of the book BICs 4 Derivatives Volume I: Theory; Part B is titled Functional Representation For BICs Pricing and is essentially chapter XI of the book BICs 4 Derivatives Volume I: Theory. The material here is intended to be read independently.

### A. The Options BICS Format And Distributional Linkage—An Alternative To Copulas

### 1. Introduction

In this chapter, we investigate a surprising theoretical application of one of the BICs formulas reviewed in chapter VI of the book BICs 4 Derivatives, Volume I, ISBN 0-9764253-0-0, the Options BIC format. Traditionally, when one has the distribution of two underlyings given independently and one needs to relate them to one another, the only available mathematical tool at one's disposal are the mathematical objects called copulas.

After briefly reviewing what copulas stand for, we outline their main properties. Then we show how the Options BICs formula can be used to achieve the same more naturally. We move even further and show how we can link any given bivariate distributions to form a multivariate distribution whose bivariate marginal distributions coincide with the given bivariate distributions. Further, we are able to propose a definition of implied correlation that naturally and intuitively extends the concept of implied volatility well known by derivatives markets practitioners.

### 2. Copulas: Definition, Main Results & Examples

### 2.1. Definition & Main Results

Definition 1. Let (X₁, . . . , Xₙ) be a random vector with cumulative distribution function F(x₁, . . . , xₙ)=Pr ob(X₁≦x₁, . . . , Xₙ≦xₙ)and marginal functions Fᵢ(xᵢ)=Pr ob(Xᵢ≦xᵢ)

A copula function of F is defined as the cumulative distribution function of a probability measure taking the value zero everywhere but on [0,1]n and verifying:

(1) For every 1≦i≦n,0≦uᵢ≦1, Cᵢ(uᵢ)=C(1, . . . , 1, uᵢ, 1, . . . , 1)=uᵢ

(2) For every (x₁, . . . , xₙ) such that xi is a continuity point of Fi(xi), (1≦i≦n), F(x₁, . . . , xₙ)=C(F₁(x₁), . . . , Fₙ(xₙ)),

Copulas satisfy the following properties:

### Theorem 1 (Sklar).

Every cumulative distribution function F has at least one copula function. When all the marginal cumulative distribution functions Fi (1≦i≦n) are continuous, the copula function C of F is unique.

### 2.2. Examples of Copulas

### Definition 2. Gaussian Copula

The Gaussian Copula C_{ρ}^{Gauss} is defined as: C_{ρ}^{Gauss}(u,v)=M(N⁻¹(u), N⁻¹(v), ρ) Definition.3.

### Definition 3. Gumbel-Hougaard Copula

The Gumbel-Hougaard Copula C_{θ}^{GumHou} is defined as: C_{θ}^{GumHou} (u,v)=e−(((−Log(u))^{θ}+(−Log(v))^{θ})^{1-θ)}

As can be seen in the definition above, copulas are tools for consistently modeling the relationship of the distribution of individual underlyings with one another. In other words, they link together individual distributions in a way that allows them to fit together

Copulas emerged in the last decade as a useful tool in financial engineering spurred by the growth of multi-underlyings derivatives contracts, and in particular credit derivatives. Credit derivatives typically, depend at least on two underlyings representing credit market risks as well as interest rate risks.

In most problems of interest, information is available about the cumulative distribution function of individual underlyings, but information about the cumulative joint distribution may not be available. Hence, there are infinitely many ways to fit together any given individual distributions, creating in practical modeling applications, the following problem.

Given any sequence of underlyings distribution, which copula function should one choose to give a realistic picture of the joint underlyings distribution?

In traditional models for derivatives pricing, geometric Brownian motion assumptions are made to model the distribution of underlyings, but under such assumptions volatility is the key parameter necessary to infer the price of vanilla call/puts.

Despite the fact that empirical evidence does not support that assumption, allowing implied volatility to be a function of the strike level allows one to recover the price yielded by any alternative model. As a result implied volatility is a market standard for quoting options prices.

A natural approach—which further illustrate our philosophy of approaching normative issues from a strong positive standpoint—more inclusive of market prices structure to infer joint distributions would desirably extend rather than change the structure of these accepted features.

In such a way, a concept of imply correlation would provide a better standard to rely on than the current alternatives developed via a copula analysis, the “compound correlation” or even the improvement provided by “base correlations.”

The BICs decomposition in the options format provides a natural method for reaching such a goal. As an alternative to copulas its salient benefits are as follows:

(1) Underlyings marginal distribution information is provided directly by options prices or implied volatilities rather than after processing to obtain joint distribution functions.

(2) Joint distribution information relationships can be provided in the form of implied correlation functions that naturally extend the concept of implied volatility functions. In such a manner joint distribution information is provided immediately in a format that makes it suitable for pricing of derivatives depending on multiple underlyings, without the need for further processing.

(3) Derivatives prices may display a more meaningful sensitivity to implied correlation than the alternative Gaussian Copula. Such sensitivity may be more comparable to the sensitivity of options prices to volatility.

This definition of implied correlation is indeed the prime candidate to solve the correlation conundrum created by the use of alternative copula functions.

How all this works is the subject of the next section.

### 3. Options BICs And Distributional Linkage

### 3.1. Option BICs Payout Payment Amount Format And Properties

Let us recall that the generic payout payment amount of such contracts at a given payout payment time T is: (δ₁(S_{T}¹−K¹))⁺ . . . (δₙ(S_{T}ⁿ−Kⁿ)⁺

where δ₁, . . . , δₙ∈{−1,1}; K¹, . . . , Kⁿ ∈□₊

### Assumption

We assume the underlyings S_{T}¹, . . . , S_{T}ⁿ are driven by a geometric brownian motion, i.e.

$$\frac{{dS}_{t}^{1}}{{S}_{t}^{1}} = ( {r}_{t}^{d} - {r}_{t}^{{f}_{1}} ) dt + {σ}_{t}^{1} {dW}_{t}^{1} ;$$

$$we note {F}_{T}^{1} = {S}_{0}^{1} {e}^{{\int }_{0}^{T} ( {r}_{t}^{d} - {r}_{t}^{{f}_{1}} ) d t} ;$$

$${σ}^{1} = \sqrt{\frac{1}{T} {\int }_{0}^{T} {( {σ}_{t}^{1} )}^{2} d t}$$

$$⋮$$

$$\frac{{dS}_{t}^{n}}{{S}_{t}^{n}} = ( {r}_{t}^{d} - {r}_{t}^{{f}_{n}} ) dt + {σ}_{t}^{n} {dW}_{t}^{n} ;$$

$$we note {F}_{T}^{n} = {S}_{0}^{1} {e}^{{\int }_{0}^{T} ( {r}_{t}^{d} - {r}_{t}^{{f}_{n}} ) d t} ;$$

$${σ}^{n} = \sqrt{\frac{1}{T} {\int }_{0}^{T} {( {σ}_{t}^{n} )}^{2} d t}$$

where rₜ^{d} is the instantaneous domestic risk free deposit rate and rₜ^{f}^{ᵢ} is the instantaneous repo/dividend/foreign rate of underlying i.

$$For 1 \leq i \leq n , \\ {W}_{t}^{i} = {\sum }_{j = 1}^{i} {ρ}_{t}^{i , j} {B}_{t}^{j}$$

$$with$$

$${ρ}_{t}^{1 , 1} = 1$$

and for

$$1 < i \leq m$$

$${ρ}_{t}^{i , i} = \sqrt{1 - {\sum }_{j = 1}^{i - 1} {( {ρ}_{t}^{i , j} )}^{2}}$$

where the (Bₜ^{j})_{1≦j≦m} are i.i.d normal variables with mean 0 and variance t.

For

$$1 \leq j \leq i \leq n , \vert {ρ}_{ij} \vert \leq 1 {S}_{t}^{i} = {F}_{t}^{i} {e}^{- \frac{1}{2} {t ( {σ}_{t}^{i} )}^{2}} {e}^{{σ}_{t}^{i} \sqrt{t} ( {\sum }_{j = 1}^{i} {ρ}_{t}^{i , j} {x}^{j} )} .$$

### Hence if

$$\overline{ρ} = {( {\overline{ρ}}_{ij} = \frac{E ( {W}_{t}^{i} , {W}_{t}^{i} )}{\sqrt{Var ( {W}_{t}^{i} ) Var ( {W}_{t}^{j} )}} )}_{1 \leq j , i \leq n}$$

is the matrix of correlations betwen the (Wₜⁱ, Wₜⁱ)_{1≦j, i≦n}, ρ̅=^{t}ρρ with ρ=(ρᵢⱼ¹_{{j≦i}})_{1≦j, i≦n}.

So it is important to bear in mind that ρ̅ and ρ are two related but distinct objects.

We provide here a “close form” solution that extends the well-known Black-Scholes formula in the case of a single risky asset following a geometric Brownian motion. In order to do so we first provide the definition of extended cumulative multivariate normal distributions that we will use here. Indeed, beyond n=2, there is no definition of the cumulative multivariate normal distribution that explicitly describes the functional relationship with the correlation coefficients. Hence, we propose here a clarifying definition that will not be simply based on the inverse of the correlation matrix and that is more suited for our purposes.

### Definition.4

For δ₁, . . . , δₙ ∈{−1, 1}; x₁, . . . , xₙ ∈□; L is a lower triangular and invertible matrix, we define:

$$\begin{matrix}{N}_{n} ( {x}_{1} , … , {x}_{n} ; {δ}_{1} , … , {δ}_{n} ; L ) = \frac{{\prod }_{k = 1}^{n} {L}_{kk}}{{( 2 π )}^{n / 2}} {\int }_{{x}_{1}}^{{δ}_{1} ∞} … {\int }_{{x}_{n}}^{{δ}_{n} ∞} Exp ( - \frac{{1}_{t}}{2} ( LT ) ( LT ) ) d {t}_{n} … d {t}_{1} = \frac{{\prod }_{i = 1}^{n} {L}_{ii}}{{( 2 π )}^{n / 2}} {\int }_{{x}_{1}}^{{δ}_{1} ∞} … {\int }_{{x}_{n}}^{{δ}_{n} ∞} Exp ( - \frac{1}{2} {\sum }_{i = 1}^{n} {( {\sum }_{j = 1}^{i} {L}_{ij} {t}_{j} )}^{2} ) d {t}_{n} … d {t}_{1} & ( i ) \\ {N}_{n} ( {x}_{1} , … , {x}_{n} ; L ) = {( - 1 )}^{n} \\ {N}_{n} ( {x}_{1} , … , {x}_{n} ; - 1 , … , - 1 ; L ) . \\ In particular we define \text{:} & ( ii ) \\ M ( {x}_{1} , {x}_{2} , ρ ) = {N}_{2} ( {x}_{1} , {x}_{2} ( \begin{matrix}1 & 0 \\ - \frac{ρ}{\sqrt{1 - {ρ}^{2}}} & \frac{1}{\sqrt{1 - {ρ}^{2}}}\end{matrix} ) ) and N ( x ) = \frac{1}{\sqrt{2 π}} {\int }_{- ∞}^{x} {e}^{- \frac{{t}^{2}}{2}} d t & ( iii )\end{matrix}$$

### Lemma.1

$$\begin{matrix} For α , a , b ∈ • , δ ∈ \{ - 1 , 1 \} , & \\ M ( a , b , ρ ) = N ( b ) - M ( - a , b , - ρ ) & ( i ) \\ \frac{1}{\sqrt{2 π}} {\int }_{α}^{δ ∞} {e}^{- \frac{{x}^{2}}{2}} d x = δ N ( - δ α ) & ( ii ) \\ \frac{1}{\sqrt{2 π}} {\int }_{α}^{δ ∞} {e}^{- \frac{{x}^{2}}{2}} {N}_{1} ( ax + b ) d x = δ M ( - δ α , \frac{b}{\sqrt{1 + {a}^{2}}} , \frac{δ a}{\sqrt{1 + {a}^{2}}} ) & ( iii ) \\ {N}_{2} ( {x}_{1} , {x}_{2} , {δ}_{1} , {δ}_{2} , ( \begin{matrix}1 & 0 \\ \frac{ρ}{\sqrt{1 - {ρ}^{2}}} & 1\end{matrix} ) ) = {δ}_{1} {δ}_{2} M ( \begin{matrix}- {δ}_{1} {x}_{1} , \\ - {δ}_{2} \sqrt{1 - {ρ}^{2}} {x}_{2} , \\ - {δ}_{1} {δ}_{2} ρ\end{matrix} ) & ( iv )\end{matrix}$$

### Theorem 2

$${\prod }_{0}^{BS} [ {( {δ}_{1} ( {S}_{T}^{1} - {K}^{1} ) )}^{+} … {( {δ}_{n} ( {S}_{T}^{n} - {K}^{n} ) )}^{+} ] = {C}_{0}^{BS , n} ( ( {δ}_{1} , … , {δ}_{n} ) , ( {K}^{1} , … , {K}^{n} ) , ( {F}_{T}^{1} , … , {F}_{T}^{n} ) , ( {σ}_{1} , … {σ}_{n} ) , {( {ρ}_{T}^{i , j} )}_{j < i} , T ) = {B}_{T}^{0} {δ}_{1} … {δ}_{n} \times {\sum }_{k = 0}^{n} {( - 1 )}^{k} {\sum }_{{1 \leq {i}_{1} < … < {i}_{k} \leq n / k + p = n}_{\{ {j}_{1} , … , {j}_{p} \} = \{ 1 , … , n \} \backslash \{ {i}_{1} , … , {i}_{k} \}}}^{ } {K}^{{i}_{1}} … {K}^{{i}_{k}} {F}_{T}^{{j}_{1}} … {F}_{T}^{{j}_{p}} {e}^{- \frac{{\sum }_{q = 1}^{p} {( {σ}_{{j}_{q}} )}^{2} - {\sum }_{k = 1}^{n} {( {\sum }_{q = 1}^{p} {σ}_{{j}_{q}} {ρ}_{T}^{{j}_{q} , k} )}^{2}}{2} T} \times {N}_{n} ( {κ}^{1} - {\sum }_{q = 1}^{p} {σ}_{{j}_{q}} {ρ}_{t}^{{j}_{q} , 1} \sqrt{T} , … , {κ}^{n} - {\sum }_{q = 1}^{p} {σ}_{{j}_{q}} {ρ}_{t}^{{j}_{q} , n} \sqrt{T} ; {δ}_{1} , … , {δ}_{n} ; L )$$

$$with {L}_{i , i} = 1 , \\ and for j < i , \\ {L}_{i , j} = \frac{{ρ}_{T}^{i , j}}{\sqrt{1 - {\sum }_{j = 1}^{i - 1} {( {ρ}_{T}^{i , j} )}^{2}}} ;$$

$${κ}^{i} = \frac{1}{{σ}_{T}^{i} \sqrt{T}} ( Log ( \frac{{K}^{i}}{{F}_{T}^{i}} ) + \frac{1}{2} {T ( {σ}_{T}^{i} )}^{2} ) ;$$

### 3.1.1. Computational Considerations

It is important to note that for any given n, the number of terms in the sum yielding the price with cumulative multivariate normal terms is 2ⁿ, an exponential growth that renders the practical use of the formula above impossible beyond a few values of n. Further compounding the complexity is the non trivial task of computing the values of the cumulative multivariate normal functions.

The description of the cumulative multivariate normal function as a function of L may facilitate the numerical approximation of these functions via limited development as a function of the values of diagonal matrices and in particular, the identity matrix as is more useful in the case at hand where the diagonal terms of L are all equal to one.

However, the formula lends itself to various qualitative analysis. A particular critical one is the generation of multivariate distributions from their univariate marginal and bivariate marginal counterparts. We will see here that this represents a very effective and less cumbersome alternative to the copula approach.

Corollary 1: If n=2,

$${C}_{0}^{BS} ( \begin{matrix}{δ}_{1} , {δ}_{2} , {K}_{1} , {K}_{2} , {σ}_{1} , {σ}_{2} , \\ ρ , T , {B}_{T}^{0} , {F}_{T}^{1} , {F}_{T}^{2}\end{matrix} ) = {\prod }_{0}^{BS} [ \begin{matrix}{( {δ}_{1} ( {S}_{T}^{1} - {K}_{1} ) )}^{+} \\ {( {δ}_{2} ( {S}_{T}^{2} - {K}_{2} ) )}^{+}\end{matrix} ] = {δ}_{1} {δ}_{2} {B}_{T}^{0} \\ ( \begin{matrix}{F}_{T}^{1} ( \begin{matrix}{F}_{T}^{2} {e}^{ρ {σ}_{1} {σ}_{2} T} M ( - {δ}_{1} ( {κ}^{1} - {σ}_{2} ρ \sqrt{T} - {σ}_{1} \sqrt{T} ) , \\ - {δ}_{2} \sqrt{1 - {ρ}^{2}} ( {κ}^{2} - {σ}_{2} \sqrt{T ( 1 - {ρ}^{2} )} ) , - {δ}_{1} {δ}_{2} ρ ) \\ - {K}^{2} M ( - {δ}_{1} ( {κ}^{1} - {σ}_{1} \sqrt{T} ) , - {δ}_{2} {κ}^{2} \sqrt{1 - {ρ}^{2}} , - {δ}_{1} {δ}_{2} ρ )\end{matrix} ) \\ - {K}^{1} ( \begin{matrix}{F}_{T}^{2} M ( - {δ}_{1} ( {κ}^{1} - {σ}_{2} ρ \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ ) \\ - {K}^{2} M ( - {δ}_{1} {κ}^{1} , - {δ}_{2} {κ}^{2} \sqrt{1 - {ρ}^{2}} , - {δ}_{1} {δ}_{2} ρ )\end{matrix} )\end{matrix} )$$

$$with \text{:}$$

$${κ}^{1} = \frac{1}{{σ}_{1} \sqrt{T}} ( Log ( \frac{{K}^{1}}{{F}_{T}^{1}} ) + \frac{1}{2} {σ}_{1}^{2} T ) ;$$

$${κ}^{2} = \frac{1}{{σ}_{2} \sqrt{T}} ( Log ( \frac{{K}^{2}}{{F}_{T}^{2}} ) + \frac{1}{2} {σ}_{2}^{2} T )$$

with: K¹=K₁ and K²=K₂ and are used interchangeably.

### 3.2. The Implied Correlation Function

### 3.2.1. Sensitivity of Second Order BICs With Respect To ρ

### Definition & Proposition. (i)

$$\begin{matrix}{M}_{1} ( x , y , z ) = \frac{\partial M}{\partial x} = \frac{{e}^{- \frac{{x}^{2}}{2}}}{\sqrt{2 π}} N ( \frac{y - zx}{\sqrt{1 - {z}^{2}}} ) ; & ( i ) \\ {M}_{2} ( x , y , z ) = \frac{\partial M}{\partial y} = \frac{{e}^{- \frac{{y}^{2}}{2}}}{\sqrt{2 π}} N ( \frac{x - zy}{\sqrt{1 - {z}^{2}}} ) = {M}_{1} ( y , x , z ) ; & ( ii ) \\ \begin{matrix}{M}_{3} ( x , y , z ) = \frac{\partial }{\partial z} M ( x , y , z ) \\ = \frac{1}{2 π \sqrt{1 - {z}^{2}}} {e}^{- \frac{{x}^{2} - 2 xyz + {y}^{2}}{2 ( 1 - {z}^{2} )}} \\ = \frac{\partial }{\partial x} \frac{\partial }{\partial y} M ( x , y , z )\end{matrix} & ( iii )\end{matrix}$$

### Proposition 1

$$\frac{\partial }{\partial ρ} {C}_{0}^{BS} ( \begin{matrix}{δ}_{1} , {δ}_{2} , {K}_{1} , {K}_{2} , {σ}_{1} , {σ}_{2} , \\ ρ , T , {B}_{T}^{0} , {F}_{T}^{1} , {F}_{T}^{2}\end{matrix} ) = {δ}_{1} {δ}_{2} {B}_{T}^{0} \times \\ ( \begin{matrix}{F}_{T}^{1} {F}_{T}^{2} {σ}_{1} {σ}_{2} T {e}^{ρ {σ}_{1} {σ}_{2} T} M ( \begin{matrix}- {δ}_{1} ( {κ}^{1} - {σ}_{2} ρ \sqrt{T} - {σ}_{1} \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} ) \\ {δ}_{1} {σ}_{2} \sqrt{T} ( \begin{matrix}{F}_{T}^{1} {F}_{T}^{2} {e}^{ρ {σ}_{1} {σ}_{2} T} {M}_{1} ( \begin{matrix}- {δ}_{1} ( {κ}^{1} - {σ}_{2} ρ \sqrt{T} - {σ}_{1} \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} ) \\ - {F}_{T}^{2} {K}^{1} {M}_{1} ( \begin{matrix}- {δ}_{1} ( {κ}^{1} - {σ}_{2} ρ \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} )\end{matrix} ) \\ ρ {δ}_{2} ( \begin{matrix}{F}_{T}^{1} ( \begin{matrix}( \frac{{κ}^{2}}{\sqrt{1 - {ρ}^{2}}} - 2 {σ}_{2} \sqrt{T} ) \\ {F}_{T}^{2} {e}^{ρ {σ}_{1} {σ}_{2} T} {M}_{2} \\ ( \begin{matrix}- {δ}_{1} ( {κ}^{1} - {σ}_{2} ρ \sqrt{T} - {σ}_{1} \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} ) \\ - \frac{{κ}^{2}}{\sqrt{1 - {ρ}^{2}}} {K}^{2} {M}_{2} \\ ( \begin{matrix}- {δ}_{1} ( {κ}^{1} - {σ}_{1} \sqrt{T} ) , \\ - {δ}_{2} {κ}^{2} \sqrt{1 - {ρ}^{2}} , \\ - {δ}_{1} {δ}_{2} ρ\end{matrix} )\end{matrix} ) \\ - {K}^{1} ( \begin{matrix}( \frac{{κ}^{2}}{\sqrt{1 - {ρ}^{2}}} - 2 {σ}_{2} \sqrt{T} ) \\ {F}_{T}^{2} {M}_{2} \\ ( \begin{matrix}- {δ}_{1} ( {κ}^{1} - {σ}_{2} ρ \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} ) \\ - \frac{{κ}^{2}}{\sqrt{1 - {ρ}^{2}}} {K}^{2} {M}_{2} \\ ( - {δ}_{1} {κ}^{1} , - {δ}_{2} {κ}^{2} \sqrt{1 - {ρ}^{2}} , \\ - {δ}_{1} {δ}_{2} ρ )\end{matrix} )\end{matrix} ) \\ - {δ}_{1} {δ}_{2} ( \begin{matrix}{F}_{T}^{1} ( \begin{matrix}{F}_{T}^{2} {e}^{ρ {σ}_{1} {σ}_{2} T} {M}_{3} ( \begin{matrix}- {δ}_{1} ( {κ}^{1} - {σ}_{2} ρ \sqrt{T} - {σ}_{1} \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} ) \\ - {K}^{2} {M}_{3} ( \begin{matrix}- {δ}_{1} ( {κ}^{1} - {σ}_{1} \sqrt{T} ) , \\ - {δ}_{2} {κ}^{2} \sqrt{1 - {ρ}^{2}} , - {δ}_{1} {δ}_{2} ρ\end{matrix} )\end{matrix} ) \\ - {K}^{1} ( \begin{matrix}{F}_{T}^{2} {M}_{3} ( \begin{matrix}- {δ}_{1} ( {κ}^{1} - {σ}_{2} ρ \sqrt{T} ) , \\ - {δ}_{2} \sqrt{1 - {ρ}^{2}} ( {κ}^{2} - {σ}_{2} \sqrt{T ( 1 - {ρ}^{2} )} ) , \\ - {δ}_{1} {δ}_{2} ρ\end{matrix} ) \\ - {K}^{2} {M}_{3} ( - {δ}_{1} {κ}^{1} , - {δ}_{2} {κ}^{2} \sqrt{1 - {ρ}^{2}} , - {δ}_{1} {δ}_{2} ρ )\end{matrix} )\end{matrix} )\end{matrix} )$$

We assume C₀^{BS}(δ₁, δ₂, K₁, K₂, σ₁, σ₂, ρ, T, B_{T}⁰, F_{T}¹, F_{T}²)as a function of ρ is monotonous. This is intuitively sensible and we can infer that for

$$\frac{\partial }{\partial ρ} {C}_{0}^{BS} ( {δ}_{1} , {δ}_{2} , {K}_{1} , {K}_{2} , {σ}_{1} , {σ}_{2} , ρ , T , {B}_{T}^{0} , {F}_{T}^{1} , {F}_{T}^{2} ) \times {δ}_{1} {δ}_{2} > 0$$

### 3.2.2. Implied Correlation Function Definition

Definition 5. For any given K₁K₂, B_{T}⁰, F_{T}¹, F_{T}², the implied correlation function ρ(K₁, K₂, T) is defined by the equation

C₀^{BS}(1,1, K₁, K₂, σ₁(K₁, T), σ₂(K₂, T), ρ(K₁, K₂, T), T, B_{T}⁰, F_{T}¹, F_{T}²)=C₀(1,1,K₁, K₂, T, B_{T}⁰, F_{T}¹, F_{T}²)

and the inequalities −1≦ρ(K₁, K₂, T)≦1. If

$$\frac{\partial }{\partial ρ} {C}_{0}^{BS} ( 1 , 1 , {K}_{1} , {K}_{2} , {σ}_{1} , {σ}_{2} , ρ , T , {B}_{T}^{0} , {F}_{T}^{1} , {F}_{T}^{2} ) \neq 0$$

then the implied correlation function is uniquely determined.

### 3.2.3. Computing the Implied Correlation Function

When the implied correlation function is uniquely determined,

$$\frac{\partial }{\partial ρ} {C}_{0}^{BS} ( 1 , 1 , {K}_{1} , {K}_{2} , {σ}_{1} , {σ}_{2} , ρ , T , {B}_{T}^{0} , {F}_{T}^{1} , {F}_{T}^{2} ) \neq 0$$

it may thus be computed by any of the following numerical methods:

### Newton Raphson Algorithm

ρ̅₀=0; (or any other good seed value)

Do

$${\overline{ρ}}_{i + 1} = {\overline{ρ}}_{i} + \frac{\begin{matrix}{C}_{0}^{Market} ( {δ}_{1} , {δ}_{2} , {K}_{1} , {K}_{2} , T ) - \\ {C}_{0}^{BS , 2} ( {δ}_{1} , {δ}_{2} , {K}_{1} , {K}_{2} , {σ}_{1} , {σ}_{2} , {\overline{ρ}}_{i} , T , {B}_{T}^{0} , {F}_{T}^{1} , {F}_{T}^{2} )\end{matrix}}{\frac{\partial }{\partial \overline{ρ}} {C}_{0}^{BS , 2} ( {δ}_{1} , {δ}_{2} , {K}_{1} , {K}_{2} , {σ}_{1} , {σ}_{2} , {\overline{ρ}}_{i + 1} , T , {B}_{T}^{0} , {F}_{T}^{1} , {F}_{T}^{2} )}$$

$$until$$

$$\vert ( \begin{matrix}{C}_{0}^{Market} ( {δ}_{1} , {δ}_{2} , {K}_{1} , {K}_{2} , T ) - \\ {C}_{0}^{BS , 2} ( {δ}_{1} , {δ}_{2} , {K}_{1} , {K}_{2} , {σ}_{1} , {σ}_{2} , {\overline{ρ}}_{i} , T , {B}_{T}^{0} , {F}_{T}^{1} , {F}_{T}^{2} )\end{matrix} ) \vert \leq ɛ ;$$

$${\overline{ρ}}^{impl} ( {K}_{1} , {K}_{2} ) = {\overline{ρ}}_{i + 1}$$

### Bisection Algorithm

ρ̅_{L}=−1; ρ̅_{H}=1; (or any other good seed value)

Do

$${\overline{ρ}}_{i + 1} = {\overline{ρ}}_{L} + \frac{( {\overline{ρ}}_{H} - {\overline{ρ}}_{L} ) ( \begin{matrix}{C}_{0}^{Market} ( {δ}_{1} , {δ}_{2} , {K}_{1} , {K}_{2} , T ) - \\ {C}_{0}^{BS , 2} ( {δ}_{1} , {δ}_{2} , {K}_{1} , {K}_{2} , {σ}_{1} , {σ}_{2} , {\overline{ρ}}_{L} , T , {B}_{T}^{0} , {F}_{T}^{1} , {F}_{T}^{2} )\end{matrix} )}{\begin{matrix}{C}_{0}^{BS , 2} ( {δ}_{1} , {δ}_{2} , {K}_{1} , {K}_{2} , {σ}_{1} , {σ}_{2} , {\overline{ρ}}_{H} , T , {B}_{T}^{0} , {F}_{T}^{1} , {F}_{T}^{2} ) - \\ {C}_{0}^{BS , 2} ( {δ}_{1} , {δ}_{2} , {K}_{1} , {K}_{2} , {σ}_{1} , {σ}_{2} , {\overline{ρ}}_{L} , T , {B}_{T}^{0} , {F}_{T}^{1} , {F}_{T}^{2} )\end{matrix}}$$

$$If ( {C}_{0}^{Market} ( {δ}_{1} , {δ}_{2} , {K}_{1} , {K}_{2} , T ) - {C}_{0}^{BS , 2} ( {δ}_{1} , {δ}_{2} , {K}_{1} , {K}_{2} , {σ}_{1} , {σ}_{2} , {\overline{ρ}}_{i + 1} , T , {B}_{T}^{0} , {F}_{T}^{1} , {F}_{T}^{2} ) ) > 0 , \\ {\overline{ρ}}_{L} = {\overline{ρ}}_{i + 1} , else {\overline{ρ}}_{H} = {\overline{ρ}}_{i + 1}$$

$$Until \vert ( \begin{matrix}{C}_{0}^{Market} ( {δ}_{1} , {δ}_{2} , {K}_{1} , {K}_{2} , T ) - \\ {C}_{0}^{BS , 2} ( {δ}_{1} , {δ}_{2} , {K}_{1} , {K}_{2} , {σ}_{1} , {σ}_{2} , {\overline{ρ}}_{i + 1} , T , {B}_{T}^{0} , {F}_{T}^{1} , {F}_{T}^{2} )\end{matrix} ) \vert \leq ɛ ;$$

$${\overline{ρ}}^{impl} ( {K}_{1} , {K}_{2} ) = {\overline{ρ}}_{i + 1} ;$$

Remark 1. There are several other implied correlation computation methods, and various approximations. Many of these approximation methods may simply adapt to the dimension 2 the approximation methods of the one dimension case.

In particular, adaptation of methods such as the at the money forward approximation of Brenner and Subramanyam (1988), the Corrado and Miller extended moneyness approximation (1996) maybe particularly appropriate. See p. 172 [113].

In addition, we can also adapt the seeding value derivation method of Manaster and Koehler (1982) to speed the convergence of the Newton Raphson or bisection iterative numerical algorithms.

### 3.3. Application of the Formula For the Generation of Non Trivial Multidimensional Densities

We know that in the case of a single asset, the density can be expressed in the form of implied volatility functions by inversion of the Black Scholes formula.

Recall that if the price of the option is,

Via the Newton raphson algorithm, if S>Call(S,K,T,)>B0(F−K) the algorithm:

Given ε arbitrarily small

$${σ}_{1}^{0} = \sqrt{\vert \frac{2}{T} Log ( \frac{{F}_{T}^{1}}{{K}_{1}} ) \vert}$$

(or any other given good seed value)

Do

$${σ}_{1}^{i + 1} = {σ}_{1}^{i} + \frac{{C}_{0}^{Market} ( {K}_{1} T ) - {C}_{0}^{BS} ( {K}_{1} , {σ}_{1}^{i} , T , {B}_{T}^{0} , {F}_{T}^{1} )}{{VegaC}_{0}^{BS} ( {K}_{1} , {σ}_{1}^{i} , T , {B}_{T}^{0} , {F}_{T}^{1} )}$$

until |C₀^{Market} (K₁,T)−C₀^{BS} (K₁, σ₁ⁱ⁺¹, T, B_{T}⁰, F_{T}¹)≦ε; σ₁^{implied} (K₁)=σ₁ⁱ⁺¹ yields in very few steps the implied volatility as a function of K

Let's suppose we have n assets and via the prices of calls and puts on the we have their implied volatility function σ₁^{impl} (K₁) and σ₂^{impl} (K₂).

We plug those implied volatility function in the second order BIC price formula C₀^{BS} (δ₁, δ₂, K₁, K₂, σ₁^{impl} (K₁), σ₂^{impl} (K₂), ρ, T, B_{T}⁰, F_{T}¹, F_{T}²). Given a continuum of second order BICs prices, we then compute the implied correlation function as indicated above.

C₀^{M, n}((δ₁, . . . , δₙ), (K¹, . . . , Kⁿ), T)=C₀^{BS, n}((δ₁, . . . , δₙ), (K¹, . . . , Kⁿ), (F_{T}¹, . . . , F_{T}ⁿ), (σ₁(K¹), . . . , σₙ(Kⁿ)),( ρ̅_{T}^{i,j}(Kⁱ, K^{j}))_{j<i≦n}, T)

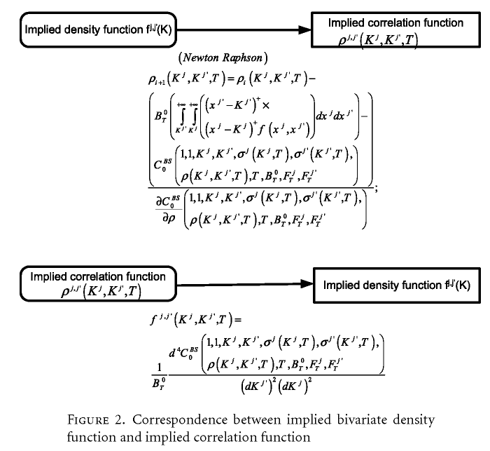

See also FIG. 2.

For n>3, it appears that we no longer have parametric freedom from which to calibrate to observed prices. This tempts us to conjecture the following:

### Theorem 3 (Conjecture)

If fn(x) n>2 is a density function such that the marginal density of any two variables is known. Then fn(x) is uniquely determined.

### 3.3.1. Implied Distribution Derivation

The multivariate distribution function can be inferred from the Options BICs prices provided in a continuum via the formula

When Option BICs prices are given by the implied volatility and correlation functions, the multivariate density is uniquely determined.

However, while performing this derivation in an analytical manner, the number of terms quickly explodes. It is however clear that in practice, for pricing purposes, there will be very little need to compute the density when the BICs prices are available

### B. Functional Representations For BICs Pricing

### 1. Problem Statement

The main purpose of this chapter is to answer the question: How do we deal computationally with premium payment functions used and obtained in the backward recursive procedure for the pricing of derivatives contracts?

Hence, we rephrase the issue as: How do we most efficiently represent functions we are likely to face here in computing terms? How do we perform operations on them, how do we add or multiply them?

The problem is not trivial. Naive choices may result in computational problems that grow exponentially with the number of time steps.

When the derivatives contract is so-called path-dependent, there is a problem of price storage as one must compute this through time for all the possible values the underlying upon which the derivatives contract depend at each time step.

### 2. Solution Philosophy: The Law of the Few

Prior to any quantitative analysis, it is perhaps useful to synthesize our solution argument in philosophical principles that one can intuitively relate to in many other circumstances.

The value of such an approach is to enable the inquisitive reader identify in a number of similar yet seemingly unrelated situations, the predictable methodological pathway to solutions of apparently intractable problems.

The terminology The Law of the Few is borrowed from the Chapter II title of Science Journalist Malclom Gladwell's book The Tipping Point How Little things can make a big difference. In this brilliant essay, Mr. Gladwell explains in a very accessible pedagogical style how a small number of properly targeted connectors, mavens and salesmen can spread news or information that trigger unprecedented chains of events. He illustrates this analysis with such examples as the comparative narrative of Paul Revere's ride and Stanley Milgrom's famous six degrees of separation experiment.

The American political landscape provides numerous other examples where the Law of the Few proposition is repeatedly verified. The incredibly critical role that two relatively minor states such as Iowa and New Hampshire play in determining who eventually gets the nomination of the two leading political parties is illustrative. The outcome of Fall presidential elections often reduces to a very narrow fight in a limited number of key states and this may confound the novice blindly looking at their relatively limited number of electoral votes. A substantial part of political pundits' research aims at identifying very quickly, which few factors can be acted upon to decisively tip the balance in favor of their candidate.

In business or mass media marketing, the almost sacred law of effective communication is to reduce all messages one would want to transmit to a few carefully selected single bullet points repeatedly stated. Otherwise, the evidence has uncovered, the message gets lost to the audience.

In macroeconomic policy, empirical evidence has shown that the single most effective tools at the disposal of governments and central banks to cool or stimulate economic activity are monetary policy through the act of raising or cutting key interest rates on one hand or fiscal policy through the act of raising or cutting a few key tax rates.

In mathematics, when establishing natural or desirable algebraic properties, one often finds that what is easily proved in the introductory trivial cases, suddenly stops working beyond a few given orders, apparently inexplicably. The initiated reader may immediately think about the impossibility of algebraic factorization of polynomials of order higher than four into polynomials of order one that is also known as the Galois Theorem. One may also think in some ways about the last Fermat theorem that puzzled the mathematical community for centuries. The above mathematical parallels, while historically interesting, may not translate to any practical benefit for the issue at hand.

In his book A New Kind of Science, Stephen Wolfram from a cellular automata perspective, further illustrate the Law of the few by expanding considerably on the observation that complicated phenomena may be explained by simple underlying mechanisms. His argument is supported by connections to numerous fields of science, including artificial intelligence, biology, chaos theory, computer science, consciousness, economics, extra-terrestrial intelligence, fluid dynamics, logic, mathematics and physics.

In relation to our subject matter, it is perhaps less surprising to see how authors such as Sahalia 1 among others are able to report that diffusion processes and even Levy Processes conditional densities can be recovered in Hermite polynomials series using less than a handful terms.

Indeed the most compelling illustration of this Law of the Few is that the reduction of BICs to merely the underlying and bonds as is done in the Black Scholes analysis under the dynamic efficiency assumption has been acceptable as replication tool for derivatives hedging for a while.

Our enunciation of the Law of the few here will concentrate on a few tools whose demonstration may not seem so sophisticated but whose application effectively provide compelling solutions to the Derivatives under BICs pricing problems, problems whose intractability has often been stressed under the quote often attributed to Richard Bellman: “The curse of Dimensionality.”2 We get rid of the curse here with two tools: the change of variable exact representation techniques and the basis projection approximation tools. In Chapter XII, these will be supplemented with low discrepancy sequences for multi-dimensional integration and Principal Component Analysis techniques.

The Law of the few may be given a more scientific argumentation by relating it to the second law of thermodynamics in the principle of entropy. Here the entropic connection with the law of the few may be stated as: systems tend to store information in a manner that minimizes the state of disorder. Acknowledging this rule reduces the problems to finding the right storage rule.

The principle of entropy minimization has been so far used in finance to address derivatives prices calibration issues as will be further seen in Volume II.

### 3. The Law of the Few In the BICs Analysis

### 3.1. Effective Dimension Reduction By Variable Changes

For substantially most of the payoff structures of derivatives contracts, it is possible to make changes of variables so that at each stage of the iterative process yielding the price of the derivatives contract, the intermediate prices are functions of at most two or three variables. The generality of this proposition can be articulated in the following:

### Proposition 1

Let us suppose there exists a sequence of functions gᵢ and a vector sequence (Xᵢ)_{i≧k} such that for any i≧k,Xᵢ₊₁=gᵢ (Xᵢ,Sᵢ₊₁) and Π_{k,i+1,n}^{0,+/-}(ƒ)(Sₖ₊₁; . . . ; Sᵢ₊₁)=Π_{k,i+1,n}^{0,+/-}(ƒ)(Xᵢ₊₁).

Let us also suppose

$${( {B}_{i + 1} ( K , {S}_{i + 1} ) )}_{K ∈ {I}_{{S}_{i + 1}}}$$

is the list of payout payment functions of the selected BIC set at time tᵢ₊₁ and there exists a sequence of functions hᵢ and a vector sequence (Yᵢ)_{i≧k} such that for any i≧k,Yᵢ₊₁=hᵢ (Xᵢ, Sᵢ₊₁) and

$${( {Π}_{k , i}^{0 , + / -} ( {B}_{i + 1} ( K , {S}_{i + 1} ) ) )}_{K ∈ {I}_{{S}_{i + 1}}} = {( {h}_{i} ( K , {Y}_{i} ) )}_{K ∈ {I}_{{S}_{i + 1}}} .$$

We note

$${( {ϒ}_{k , i + 1 , n}^{f , 0 , + / -} ( K ) )}_{K ∈ {I}_{{S}_{i + 1}}}$$

the list of coordinates of Π_{k,i+1,n}^{0,+/-}(ƒ)(Sₖ₊₁; . . . ; Sᵢ₊₁) in the BIC set

$${( {B}_{i + 1} ( K , {S}_{i + 1} ) )}_{K ∈ {I}_{{S}_{i + 1}}} ,$$

Then Π_{k,i,n}^{0,+/-}(ƒ) can be reduced to a function of Xᵢ and Yᵢ or a a function of Xᵢ₋₁, Yᵢ₋₁ and Sᵢ.

### Proof

$${Π}_{k , i , n}^{0 , + / -} ( f ) ( {S}_{k + 1} ; … ; {S}_{i} ) = {\sum }_{K ∈ {I}_{{S}_{i + 1}}} {ϒ}_{k , i + 1 , n}^{f , 0 , + / -} ( {S}_{k + 1} ; … ; K ) \times {Π}_{k , i}^{0 , + / -} ( {B}_{i + 1} ( K , {S}_{i + 1} ) )$$

$${ϒ}_{k , i + 1 , n}^{f , 0 , + / -} ( {S}_{k + 1} ; … ; K ) can also be written as {ϒ}_{k , i + 1 , n}^{f , 0 , + / -} ( {g}_{i} ( {X}_{i} , K ) ) , so \text{:}$$

$$\begin{matrix}{Π}_{k , i , n}^{0 , + / -} ( f ) ( {S}_{k + 1} ; … ; {S}_{i} ) = {\sum }_{K ∈ {I}_{{S}_{i + 1}}} {ϒ}_{k , i + 1 , n}^{f , 0 , + / -} ( {g}_{i} ( {X}_{i} , K ) ) \times {h}_{i} ( K , {Y}_{i} ) \\ = {Π}_{k , i , n}^{0 , + / -} ( f ) ( {X}_{i} , {Y}_{i} )\end{matrix}$$

$${Π}_{k , i , n}^{0 , + / -} ( f ) ( {S}_{k + 1} ; … ; {S}_{i} ) = {\sum }_{K ∈ {I}_{{S}_{i + 1}}} {ϒ}_{k , i + 1 , n}^{f , 0 , + / -} ( {g}_{i} ( {g}_{i - 1} ( {X}_{i - 1} , {S}_{i} ) , K ) ) \times {h}_{i} ( K , {h}_{i - 1} ( {Y}_{i - 1} , {S}_{i} ) )$$

$${Π}_{k , i , n}^{0 , + / -} ( f ) ( {S}_{k + 1} ; … ; {S}_{i} ) = {Π}_{k , i , n}^{0 , + / -} ( f ) ( {X}_{i - 1} , {Y}_{i - 1} , {S}_{i} )$$

The World Series baseball illustration of chapter IV is a prime example where the use of such auxiliary variables provide a noticeable computational simplification. Indeed, we write the payoff there as:

$$f ( {X}_{{t}_{1}} , … , {X}_{{t}_{7}} ) = {1}_{\{ {\sum }_{j = 1}^{7} {X}_{{t}_{j}} \geq 4 \}} = {1}_{\{ {Y}_{{t}_{6}} + {X}_{{t}_{7}} \geq 4 \}}$$

$$with {Y}_{{t}_{n + 1}} = {g}_{n} ( {Y}_{{t}_{n}} , {X}_{{t}_{n + 1}} ) = {Y}_{{t}_{n}} + {X}_{{t}_{n + 1}}$$

$$for n = 0 , … , 6$$

A few examples of payout payment functions of some well-known European derivative contracts further illustrate how these auxiliary variables can be identified naturally and, pending specification of the BICs premium payment functions, these are:

### EXAMPLE

### Sample Reduced Form Derivatives Payouts

1. Double Barrier Option, with lower barrier L and upper barrier H,

$${f}_{0}^{n} ( {S}_{0} ; … ; {S}_{n} ) = {( δ ( {S}_{n} - \overline{K} ) )}^{+} {1}_{\{ L < {S}_{n} < H \}} \times … \times {1}_{\{ L < {S}_{1} < H \}}$$

$${f}_{0}^{n} ( {S}_{0} ; … ; {S}_{n} ) = {( δ ( {S}_{n} - \overline{K} ) )}^{+} {1}_{\{ L < {S}_{n} < H \}} \times {1}_{\{ Max \{ {X}_{n - 1}^{1} , {S}_{n} \} < H \}} {1}_{\{ L < Min \{ {X}_{n - 1}^{2} , {S}_{n} \} \}} , \\ with$$

$${X}_{i + 1} = ( \begin{matrix}{X}_{i + 1}^{1} \\ {X}_{i + 1}^{2}\end{matrix} ) = ( \begin{matrix}{Max}_{0 \leq k \leq n} {S}_{k} \\ {Min}_{0 \leq k \leq n} {S}_{k}\end{matrix} ) = ( \begin{matrix}Max \{ {X}_{i}^{1} , {S}_{i + 1} \} \\ Min \{ {X}_{i}^{2} , {S}_{i + 1} \}\end{matrix} )$$

2. Asian Option

$$, {f}_{0}^{n} ( {S}_{0} ; … ; {S}_{n} ) = {( δ ( \frac{1}{n} ( {\sum }_{k = 1}^{n} {S}_{k} ) - \overline{K} ) )}^{+} = {( δ ( \frac{1}{n} ( {X}_{n - 1} + {S}_{n} ) - \overline{K} ) )}^{+} ,$$

with

$${X}_{i + 1} = {\sum }_{k = 1}^{i + 1} {S}_{k} = {X}_{i} + {S}_{i + 1} ;$$

3. Lookback Option

$$, {f}_{0}^{n} ( {S}_{0} ; … ; {S}_{n} ) = ( {Max}_{1 \leq k \leq \leq n} {S}_{k} - {\overline{K}}_{n} ) = ( Max \{ {X}_{n - 1} , {S}_{n} \} - {\overline{K}}_{n} ) ,$$

with Xᵢ₊₁=Max {Xᵢ,Sᵢ₊₁}; or

$${f}_{0}^{n} ( {S}_{0} ; … ; {S}_{n} ) = ( {K}_{n} - {Min}_{1 \leq k \leq \leq n} {S}_{k} ) = ( {K}_{n} - Min \{ {X}_{n - 1} , {S}_{n} \} )$$

$$with {X}_{i + 1} = Min \{ {X}_{i} , {S}_{i + 1} \} ;$$

4.Volatility Swap,

$${f}_{0}^{n} ( {S}_{0} ; … ; {S}_{n} ) = \sqrt{\frac{252}{n - 1} {\sum }_{k = 1}^{n} {( Log [ \frac{{S}_{k}}{{S}_{k - 1}} ] - \frac{1}{n} ( {\sum }_{i = 1}^{n} Log [ \frac{{S}_{i}}{{S}_{i - 1}} ] ) )}^{2}} - \overline{K} ;$$

$${f}_{0}^{n} ( {X}_{n - 1} , {S}_{n - 1} , {S}_{n} ) = \sqrt{\frac{252}{n - 1} ( {X}_{n - 1} + {Log [ \frac{{S}_{n}}{{S}_{n - 1}} ]}^{2} + \frac{( 1 - 2 n )}{{n}^{2}} {Log [ \frac{{S}_{n}}{{S}_{0}} ]}^{2} )} - \overline{K} , \\ with {X}_{i + 1} = {\sum }_{k = 1}^{i + 1} Log {\{ \frac{{S}_{k}}{{S}_{k - 1}} ]}^{2} = {X}_{i} + {Log [ \frac{{S}_{i + 1}}{{S}_{i}} ]}^{2} ;$$

One may also see in many of the examples reviewed in Volume II BICs 4 Derivatives Volume II: Applications how this transformation is used for derivatives pricing. This includes the pricing of American options, baseball options, CMOs, passport options, etc. In most of those examples, we see that the selected change of variable in each case reduces the number of variables to one or two.

Indeed, the markovian dynamic of the underlyings as is primarily assumed in current stochastic processes based modeling assumptions implies that in the specification of the BICs premium payment functions, Yᵢ reduces to merely Sᵢ, providing a very desirable level of simplifications. The derivatives contract premium payment function at each trading time ti reduces to a function of Xᵢ₋₁ and Sᵢ.

Dimension reduction by change of variables is a core principle for reducing computational costs. The Girsanov Theorem and its applications for change of measure, which provide the means for various computation reductions for derivatives pricing in Gaussian processes is indeed a change of variable to facilitate integrations.

### 3.2. General Approach For Computational Tractability By Projection On Appropriate Representation Spaces

### 3.2.1. Problem Statement

Viewed with the information of time tₖ, k<i, Π_{k,i,n}^{0,+/-}(ƒ) is in general a function of Sₖ₊₁, . . . Sᵢ,Π_{k,i,n}^{0,+/-}(ƒ)(Sₖ₊₁, . . . Sᵢ).

When there are opportunities to introduce auxiliary variables as introduced in the previous section, we have Π_{k,i,n}^{0,+/-}(ƒ)(Sₖ₊₁, . . . Sᵢ)=Π_{k,i,n}^{0,+/-}(ƒ)(Xᵢ₋₁, Yᵢ₋₁,Sᵢ).

When the dynamic of the underlying is markovian, we have: Π_{k,i,n}^{0,+/-}(ƒ)(Sₖ₊₁, . . . Sᵢ)=Π_{k,i,n}^{0,+/-}(ƒ)(Xᵢ₋₁,Sᵢ).

In each of these cases, for the function to be fully described, one must have, readily available, the realized value of the function for each possible value of its variables.

Hence, in the iterative relationship of chapter V, when we write,

$${Π}_{k , i , n}^{0 , + / -} ( f ) ( {S}_{k + 1} ; … ; {S}_{i} ) = {\sum }_{K ∈ {I}_{{S}_{i + 1}}} {ϒ}_{k , i + 1 , n}^{f , 0 , + / -} ( {g}_{i} ( {g}_{i - 1} ( {X}_{i - 1} , {S}_{i} ) , K ) ) \times {h}_{i} ( K , {h}_{i - 1} ( {Y}_{i - 1} , {S}_{i} ) )$$

We are actually making an inner product of functions. This may actually mean that at each step, the corresponding number of computations may be multiplied by the number of possible values the variables may take.

For instance, if we note Cardinal (I_{S}_{ᵢ})=Sᵢ, Cardinal (I_{X}_{ᵢ})=xᵢ, Cardinal (I_{Y}_{ᵢ})=yᵢ and where Cardinal ( ) represents the number of elements of the set between brackets. The inner product above actually represents sᵢ×xᵢ×yᵢ inner products, where an inner product is actually sᵢ₊₁ multiplications and sᵢ₊₁−1 additions.

We have earlier proposed methods to reduce the number of variables. This will work in many cases, but in cases such as basket options and their many flavors, it is very clear that it will quickly become unpractical to compute that quantity for each possible value of S₁; . . . ;Sᵢ₋₁ and that an appropriate change of variable may not be sufficient to reduce the problem to tractability.

To address such a problem, we need to select effective basis of representations that will enable reconstructions of those functions in each case merely from a few coefficients that can be computed.

The goal of this section is to leverage the abundant literature on functional representations to reduce the sᵢ×xᵢ33 yᵢ number of inner products to a more tractable number.

### 3.2.2. Solution

The general idea of our solution approach that quantitatively articulate the law of the few is as follows:

Let's suppose f is a function that can be decomposed in a functional basis B=(bₖ)_{k∈ℑ}, i.e. there exist a unique vector (δₖ)_{k∈ℑ} such that

$$f = {\sum }_{k ∈ 𝒥} {δ}_{k} {b}_{k} ,$$

where ℑ is a finite or infinite indexing set, such as the set of integers or non negative integers.

For any given error tolerance level ε, the basis selection goal is to choose B such that there exist a finite subset of the indexing set ℑₛ⊂ℑ small enough such that for any function f belonging to the set of functions of interest, and for a given norm of reference [[]], we have:

$$‖ f - {\sum }_{k ∈ {𝒥}_{s} ⋐ 𝒥} {δ}_{k} {b}_{k} ‖ < ɛ$$

We approach this solution with the restatement of a classic result of quadratic optimization.

### Proposition 2

Let us assume the function f is to be approximated by f₁(X), . . . , fₙ(X) for integration purposes.

Let us also suppose that none of the fᵢ can be obtained as a linear combination of the others, i.e. the functions are linearly independent.

Let's Call Δ the definition set of X and μ a Measure on a field on X.

We note

$${a}_{i , j} = {\int }_{Δ} {f}_{i} ( X ) {f}_{j} ( X ) d μ ( X ) ;$$

$${b}_{j} = {\int }_{Δ} {f}_{j} ( X ) f ( X ) d μ ( X ) ;$$

$$A = {( {a}_{i , j} )}_{{1 \leq i \leq n}_{1 \leq j \leq n}} ;$$

$$B = {( {b}_{j} )}_{1 \leq j \leq n} ;$$

Let's call α^{f} the vector of coefficients approximating f in the basis of f₁(X), . . . ,fₙ(X).

Then, with respect to the norm

$${‖ f ‖}_{2} = \sqrt{{\int }_{Δ} {f}^{2} ( X ) d μ ( X )} , \\ {Arg Min}_{{( {α}_{j}^{f} )}_{j = 1 … n}} {‖ f - {\sum }_{j = 1}^{n} {α}_{j}^{f} {f}_{j} ‖}_{2} = {A}^{- 1} B$$

$$with \text{:}$$

$${Min}_{{( {α}_{j}^{f} )}_{j = 1 … n}} {‖ f - {\sum }_{j = 1}^{n} {α}_{j}^{f} {f}_{j} ‖}_{2}^{2} = {‖ f ‖}_{2}^{2} - {}_{}^{t}{BA}{}_{}^{- 1} B$$

Proof. The proof is trivial by noting that the gradient vector equals zero only at the single point A⁻¹B. Then one verifies that the Hessian A is symmetric positive definite at that point

When one needs to represent a function and compress the amount of information about the function that needs to be stored or transmitted, what comes immediately to the trained engineer's mind are Fourier Series representation, Wavelets series representation, Polynomials or Hermite Polynomials.

These methods have been tried and tested in many fields of engineering and perform well in these settings. Fourier series representations are particularly effective when the functions under consideration are very smooth. In a discrete space representation, the COR-IP statement means we can extend the function in a continuous space to any level of regularity desired. Our presentation here did not limit itself to functions that form a Hilbertian Basis because we may have cases where we have an intuition on the shape of functions that may approximately reconstruct the functions at hand. Such functions may not constitute a Hilbert Basis, yet may help achieve better compression. In those instances, the formula above, where we implicitly orthogonalize the basis functions, may prove very helpful.

Let's now review an example that gives us the opportunity to see change of variables and functional projections in action, the case of volatility swaps

### 3.2.3. Application—Example: Volatility And Moments Derivatives

Let us suppose our goal is to apply the above functional representation approach with effective dimension reduction by variable change to price volatility derivatives.

We recall that the payoff at payout payment time of the volatility swap contract is generally described with the following representation:

Volatility Swap,

$${f}_{n}^{0} ( {S}_{0} ; … ; {S}_{n} ) = \sqrt{\frac{252}{n - 1} {\sum }_{k = 1}^{n} {( Log [ \frac{{S}_{k}}{{S}_{k - 1}} ] - \frac{1}{n} ( {\sum }_{i = 1}^{n} Log [ \frac{{S}_{i}}{{S}_{i - 1}} ] ) )}^{2}} - \overline{K} ;$$

we note:

$${V}_{n} • {\sum }_{k = 1}^{n} {( Log [ \frac{{S}_{k}}{{S}_{k - 1}} ] - \frac{1}{n} ( {\sum }_{i = 1}^{n} Log [ \frac{{S}_{i}}{{S}_{i - 1}} ] ) )}^{2} ;$$

This allows us to propose the following clarifying definition

### Definition

A volatility derivatives contract is a derivatives contract whose payout payment function is a function of the realized values of underlying expressed as a function of the function Vn of the underlyings.

We focus first on effective dimension reduction by variables change.

### Lemma 1

$${V}_{n} = {M}_{n}^{2} - \frac{1}{n} {( {M}_{n}^{1} )}^{2} , \\ with$$

$${X}_{i} • Log [ \frac{{S}_{i}}{{S}_{i - 1}} ] ;$$

$${M}_{k}^{1 } • {\sum }_{i = 1}^{k} {X}_{i} ;$$

$${M}_{k}^{2 } • {\sum }_{i = 1}^{k} {X}_{i}^{2} ;$$

### Proof

$${V}_{n} • {\sum }_{k = 1}^{n} {( Log [ \frac{{S}_{k}}{{S}_{k - 1}} ] - \frac{1}{n} ( {\sum }_{i = 1}^{n} Log [ \frac{{S}_{i}}{{S}_{i - 1}} ] ) )}^{2} ; = {\sum }_{k = 1}^{n} ( {Log [ \frac{{S}_{k}}{{S}_{k - 1}} ]}^{2} - \frac{2}{n} Log [ \frac{{S}_{k}}{{S}_{k - 1}} ] ( {\sum }_{i = 1}^{n} Log [ \frac{{S}_{i}}{{S}_{i - 1}} ] ) + \frac{1}{{n}^{2}} {( {\sum }_{i = 1}^{n} Log [ \frac{{S}_{i}}{{S}_{i - 1}} ] )}^{2} ) = {\sum }_{k = 1}^{n} {Log [ \frac{{S}_{k}}{{S}_{k - 1}} ]}^{2} - \frac{1}{n} {( {\sum }_{i = 1}^{n} Log [ \frac{{S}_{i}}{{S}_{i - 1}} ] )}^{2} ;$$

### 3.2.3. 1.From the Computationally Impossible To the Computationally Possible Through the Use of Summarizing Variables

We move from the computationally impossible to the computationally possible in the pricing and hedging of volatility derivatives contracts through the BICs analysis. This is done by showing that the variables Mₖ¹ and Mₖ² can be used as the function upon which at each stage the premium payment amounts depend, especially in the case of underlyings with independent increments such as those driven by Levy processes.

Once the dependence on (Mₖ¹,Mₖ²k) at time tk established, we estimate how large the set of values spanned is.

### States Spanned By (Mₖ¹,Mₖ²)

A few considerations,

$${Δ}_{i}^{x} • \frac{{h}_{i} - {l}_{i}}{2 {p}_{i}} ;$$

$${s}_{i}^{x} = 2 {p}_{i} + 1$$

$${X}_{i} • \frac{{h}_{i} + {l}_{i}}{2} + {j}_{i} {Δ}_{i}^{x} ;$$

$${j}_{i} ∈ \{ - {p}_{i} , … , 0 , 1 , … , {p}_{i} \} = {J}_{i}$$

$${M}_{i}^{1} = {\sum }_{k = 1}^{i} {X}_{k} = {\sum }_{k = 1}^{i} \frac{{h}_{k} + {l}_{k}}{2} + {\sum }_{k = 1}^{i} {j}_{k} {Δ}_{k}^{x} ;$$

$$\begin{matrix}{M}_{i}^{2} = {\sum }_{k = 1}^{i} {X}_{k}^{2} \\ = {\sum }_{k = 1}^{i} {( \frac{{h}_{i} + {l}_{i}}{2} + {jΔ}_{i}^{x} )}^{2} \\ = {\sum }_{k = 1}^{i} {( \frac{{h}_{k} + {l}_{k}}{2} )}^{2} + {\sum }_{k = 1}^{i} {( {j}_{k} {Δ}_{k}^{x} )}^{2} + {\sum }_{k = 1}^{i} {j}_{k} {Δ}_{k}^{x} ( {h}_{k} + {l}_{k } )\end{matrix}$$

$$If for k = 1 , … , n , {h}_{k} = h and {l}_{k} = l and$$

$${p}_{k} = p , {Δ}_{k}^{x} = {Δ}^{x} = \frac{h - l}{2 p} . \\ As a result , {M}_{i}^{1} = i \frac{h + l}{2} + {Δ}^{x} {\sum }_{k = 1}^{i} {j}_{k} ;$$

$${M}_{i}^{2} = {i ( \frac{h + l}{2} )}^{2} + ( h + l ) {Δ}^{x} {\sum }_{k = 1}^{i} {j}_{k} + {( {Δ}^{x} )}^{2} {\sum }_{k = 1}^{i} {j}_{k}^{2} ;$$

### Definition 2

For n, p positive integers, and y integer verifying |y|≦n×p,

$$( i ) {S}_{2} [ n , p ] • \{ ( {\sum }_{k = 1}^{n} {j}_{k} , {\sum }_{k = 1}^{n} {j}_{k}^{2} ) , \vert {j}_{k} \vert \leq p , k = 1 , … , p \} ; \\ ( ii ) {S}_{2} [ n , p , y ] • \{ {\sum }_{k = 1}^{n} {j}_{k}^{2} , \vert {j}_{k} \vert \leq p , {\sum }_{k = 1}^{n} {j}_{k} = y \} ; \\ ( iii ) \{ {S}_{2} [ n , p , y ] + {j}^{2} \} • \{ z + {j}^{2} , z ∈ {S}_{2} [ n , p , y ] \} ;$$

$$( iv ) {Cs}_{2} [ n , p , y ] • Cardinal {S}_{2} [ n , p , y ] • \# {S}_{2} [ n , p , y ] ;$$

### Proposition 3

For n, p positive integers and y integer verifying |y|≦n×p

$$\begin{matrix}{S}_{2} [ n , p , y ] = {⋃}_{j = - p , \vert y - j \vert \leq ( n - 1 ) p}^{p} \{ {S}_{2} [ n - 1 , p , y - j ] + {j}^{2} \} \\ = {S}_{2} [ n , p , - y ] ;\end{matrix}$$

$$For y = - p to p$$

$${S}_{2} [ 1 , p , y ] = \{ {y}^{2} \} = {S}_{2} [ 1 , p , - y ] ;$$

### Proof

$${S}_{2} [ n , p ] • \{ ( {\sum }_{k = 1}^{n} {j}_{k} , {\sum }_{k = 1}^{n} {j}_{k}^{2} ) , \vert {j}_{k} \vert \leq p , k = 1 , … , p \}$$

$${S}_{2} [ n , p ] = \{ ( y , z ) , \vert y \vert \leq np , x ∈ {S}_{2} [ n , p , y ] \} , \\ where$$

$${S}_{2} [ n , p , y ] • \{ {\sum }_{k = 1}^{n} {j}_{k}^{2} , \vert {j}_{k} \vert \leq p , {\sum }_{k = 1}^{n} {j}_{k} = y \}$$

$${S}_{2} [ n , p , y ] = \{ \begin{matrix}z + {( y - j )}^{2} , z ∈ {S}_{2} [ n - 1 , p , j ] , \\ \vert j \vert \leq ( n - 1 ) p , \vert y - j \vert \leq p\end{matrix} \}$$

$${S}_{2} [ n , p , y ] = \{ \begin{matrix}z + {j}^{2} , z ∈ {S}_{2} [ n - 1 , p , y - j ] , \\ \vert j \vert \leq p , \vert y - j \vert \leq ( n - 1 ) p\end{matrix} \}$$

$$If we note$$

$$\{ {S}_{2} [ n - 1 , p , j ] + {j}^{2} \} • \{ z + {j}^{2} , z ∈ {S}_{2} [ n - 1 , p , y - j ] \}$$

$${S}_{2} [ n , p , y ] = {⋃}_{j = - p , \vert y - j \vert \leq ( n - 1 ) p}^{p} \{ {S}_{2} [ n - 1 , p , y - j ] + {j}^{2} \}$$

$${S}_{2} [ n , p , y ] = ( {⋃}_{j = 0 , \vert y - j \vert \leq ( n - 1 ) p}^{p} \{ {S}_{2} [ n - 1 , p , y - j ] + {j}^{2} \} ) ⋃ ( {⋃}_{j = 0 , \vert y - j \vert \leq ( n - 1 ) p}^{p} \{ {S}_{2} [ n - 1 , p , y + j ] + {j}^{2} \} )$$

$$\begin{matrix}{S}_{2} [ n , p , - y ] = ( {⋃}_{j = 0 , \vert y - j \vert \leq ( n - 1 ) p}^{p} \{ {S}_{2} [ n - 1 , p , - y - j ] + {j}^{2} \} ) ⋃ \\ ( {⋃}_{j = 0 , \vert y - j \vert \leq ( n - 1 ) p}^{p} \{ {S}_{2} [ n - 1 , p , - y + j ] + {j}^{2} \} ) \\ = ( {⋃}_{j = 0 , \vert y - j \vert \leq ( n - 1 ) p}^{p} \{ {S}_{2} [ n - 1 , p , y + j ] + {j}^{2} \} ) ⋃ \\ ( {⋃}_{j = 0 , \vert y - j \vert \leq ( n - 1 ) p}^{p} \{ {S}_{2} [ n - 1 , p , y - j ] + {j}^{2} \} ) \\ = {S}_{2} [ n , p , y ]\end{matrix}$$

$$Indeed , it is trivial that for y = - p to p$$

$${S}_{2} [ 1 , p , y ] = \{ {y}^{2} \} = {S}_{2} [ 1 , p , y ] ;$$

### Proposition 4

$$\frac{{S}_{2} [ n , p ]}{{( 2 np + 1 )}^{2}} • η ; η = \frac{{π}^{2}}{6} ;$$

### Proof

As this is a sideshow to our argument here, we have not spent the time to try to rigorously prove this result and have no idea whether it is actually easy or difficult. This may be an interesting issue to investigate for the curious mathematical reader.

Our statement is purely based on empirical observations and considerations. It seems there must be some equivalence between

$$\frac{{S}_{2} [ n , p ]}{{( 2 np + 1 )}^{2}} and {\sum }_{k = 1}^{∞} \frac{1}{{k}^{2}} = \frac{{π}^{2}}{6} .$$

Another approach may be to show the equivalence with the integral of a function and compute that integral.

### Algorithm For Computing S₂[n,p,y]

$$For y = - p to p step 1 , {S}_{2} [ 1 , p , y ] = \{ {y}^{2} \} ; \\ [ \begin{matrix}For i = 2 to n step 1 \\ [ \begin{matrix}For y = - i \times p to i \times p step 1 \\ {S}_{2} [ i , p , y ] = \{ \} ; {Cs}_{2} [ i , p , y ] = 0 ; s = 0 ; (* initialization *) \\ [ \begin{matrix}For j = - p to p step 1 , \\ If \vert y - j \vert \leq ( i - 1 ) p then \\ s = Length [ {S}_{2} [ i , p , y ] ⋂ \{ {S}_{2} [ i - 1 , p , y - j ] + {j}^{2} \} ] ; \\ ( \begin{matrix}* Length is the command for computing the \\ number of elements of a set in mathematica *\end{matrix} ) \\ {S}_{2} [ i , p , y ] = {S}_{2} [ i , p , y ] ⋃ \{ {S}_{2} [ i - 1 , p , y - j ] + {j}^{2} \} \\ {Cs}_{2} [ i , p , y ] = {Cs}_{2} [ i , p , y ] + {Cs}_{2} [ i - 1 , p , y - j ] - s\end{matrix}\end{matrix}\end{matrix}$$

The following Mathematica® Code translates the algorithm

Clear[p, n, s, Sp, S2, i, j, y, t, Cs2, ts];
p= 10; n=100;
For[y= −p, y≦p, S2[1, p, y] = {y²}; Cs2[1, p, y] =1;y++];
For[i = 2, i≦n,

For[y= 0, y≦i*p,

S2[i, p, y] = { }; Cs2[i, p, y] = 0; s = 0; (*Initialization of variables*)
For[j= −p, j≦p,

If[Abs[y−j] ≦ (i−1) *p,

Sp= S2[i−1, p, y−j] + j²;
s = Length[S2[i, p, y]∩Sp];
(*Length is the function computing the Cardinal of a set in Mathematica*)
S2[i, p, y] = S2[i, p, y]∪Sp;
Cs2[i, p, y] = Cs2[i, p, y] + Cs2[i−1, p, y−j] − s

];
j++];S2[i, p, −y] = S2[i, p, y];Cs2[i, p, −y] =Cs2[i, p, y];

y++];

i++];

We can see with the code below the shape of S2[i,p,y] as a function of y looks like a bell curve and how S[i,p]/(2ip+1)̂2 asymptotically converges to the constant conjectured here as π²/6

Clear[ts];
t = Table[{y, Cs2[n, p, y]}, {y, −n * p, n * p}];
$ts = Table [ ( {\sum }_{y = - i * p}^{i * p} Cs 2 [ i , p , y ] ) / {( 2 * i * p + 1 )}^{\hat{ }} 2 // N , \{ i , 1 , n \} ] ;$
ListPlot[t]
ListPlot[ts]

### Pricing

We note fᵢ≡Π_{k,i,n}^{0,+/-}(ƒ)(Mᵢ¹,Mᵢ²) and this exercise will illustrate how we represent the functions fᵢ in the backward iterative loop to make it tractable. For ease of presentation, we assume a frictionless market with an underlying following a Markovian dynamic. We estimate the premium payment amount for time t₀.

We thus note: fᵢ(Mᵢ²,Sᵢ)≡Π_{0,i,n}⁰(ƒ)(XᵢSᵢ); S_{i=S}₀e^{M)}

The applicable backward recursive pricing formula in the Option BIC format is:

$${f}_{i} ( {M}_{i}^{2} , {S}_{i} ) = \\ ( {f}_{i + 1} ( {M}_{i}^{2} + {Log [ \frac{{F}_{i + 1}}{{S}_{i}} ]}^{2} , {F}_{i + 1} ) - {\partial }_{2}^{1} {f}_{i + 1} ( {M}_{i}^{2} + {Log [ \frac{{F}_{i + 1}}{{S}_{i}} ]}^{2} , {F}_{i + 1} ) {F}_{i + 1} ) {B}_{0 , i , i + 1}^{0} + {\partial }_{2}^{1} {f}_{i + 1} ( {M}_{i}^{2} + {Log [ \frac{{F}_{i + 1}}{{S}_{i}} ]}^{2} , {F}_{i + 1} ) {S}_{i} {B}_{0 , i , i + 1}^{1} + \\ {F}_{i + 1} ( {\int }_{0}^{1} {\partial }_{2}^{2} {f}_{i + 1} ( {M}_{i}^{2} + {Log [ \frac{{F}_{i + 1}}{{xS}_{i}} ]}^{2} , {F}_{i + 1} / x ) {B}_{0 , i , i + 1}^{0} ( 1 , {F}_{i + 1} / {x}^{-} ) ( {S}_{i} ) \frac{d x}{{xx}^{-}} + {\int }_{0}^{1} {\partial }_{2}^{2} {f}_{i + 1} ( {M}_{i}^{2} + {Log [ \frac{{xF}_{i + 1}}{{S}_{i}} ]}^{2} , {F}_{i + 1} x ) {B}_{0 , i , i + 1}^{0} ( - 1 , {F}_{i + 1} {x}^{+} ) ( {S}_{i} ) d x )$$

The derivatives with respect to Sₙ are indeed meant in the discrete sense subordinated to the applicable space partition:

$${f}^{′} ( x ) = \frac{f ( {x}^{+} ) - f ( x )}{{x}^{+} - x} ;$$

$${f}^{″} ( x ) = \frac{{f}^{′} ( {x}^{+} ) - {f}^{′} ( x )}{{x}^{+} - x} = \frac{\frac{f ( {x}^{++} ) - f ( {x}^{+} )}{{x}^{++} - {x}^{+}} - \frac{f ( {x}^{+} ) - f ( x )}{{x}^{+} - x}}{{x}^{+} - x}$$

The applicable backward recursive pricing formula in the Fourier BIC format is:

$${f}_{i} ( {M}_{i}^{2} , {S}_{i} ) = {B}_{0 , i , i + 1}^{0} {\sum }_{n = - ∞}^{+ ∞} {c}_{n} ( {M}_{i}^{2} , {S}_{i} ) E ( {e}^{\frac{2 iπ {nS}_{i + 1}}{{H}_{i + 1} - {L}_{i + 1}}} / {S}_{i} ) , \\ with$$

$${c}_{n} ( {M}_{i}^{2} , {S}_{i} ) = \frac{1}{{H}_{i + 1} - {L}_{i + 1}} {\int }_{{L}_{i + 1}}^{{H}_{i + 1}} {e}^{\frac{- 2 i π nx}{{H}_{i + 1} - {L}_{i + 1}}} {f}_{i + 1} ( {M}_{i}^{2} + {Log [ \frac{x}{{S}_{i}} ]}^{2} , x ) d x$$

In each of the BIC format representations above, when use the naïve representation of functions, we must make the computations over the span of S₂[n,p] as we move recursively backwards through time representing about O((2ip+1)²(2p+1)) additions and multiplications at each time step. This is indeed possible and doable in a BICs trading system, where every derivatives contract is recomposed from the price of actually quoted BICs. However, if one is merely interested in pricing in the traditional frictionless framework for instance, substantial computational savings become possible.

### 3.2.3.2.From the Computationally Possible To the Computationally Optimal For Pricing

In fact, by selecting the right functional representation basis functions of premium payment amounts coupled with the summarizing variables selected above, one can come as close to a close form solution for the premium payment amount at time 0 as one can hope for. Indeed,

$${V}_{n} = {M}_{n}^{2} - \frac{1}{n} {( {M}_{n}^{1} )}^{2}$$

$$with$$

$${X}_{i} = Log [ \frac{{S}_{i}}{{S}_{i - 1}} ] ;$$

$${M}_{k}^{1} = {\sum }_{i = 1}^{k} {X}_{i} ;$$

$${M}_{k}^{2} = {\sum }_{i = 1}^{k} {X}_{i}^{2} ;$$

We use the Fourier space functional representation.

For any function ƒ of two variables integrable,

$$f ( {x}_{1} , {x}_{2} ) = {\int }_{- ∞}^{+ ∞} {\int }_{- ∞}^{+ ∞} \tilde{f} ( {t}_{1} , {t}_{2} ) {e}^{2 i π ( {t}_{1} {x}_{1} + {t}_{2} {x}_{2} )}$$

dt₁dt₂; with

$$\tilde{f} ( {t}_{1} , {t}_{2} ) = {\int }_{- ∞}^{+ ∞} {\int }_{- ∞}^{+ ∞} f ( {x}_{1} , {x}_{2} ) {e}^{- 2 i π ( {t}_{1} {x}_{1} + {t}_{2} {x}_{2} )} d {x}_{1} d {x}_{2} ;$$

A volatility derivatives contract is a contract whose payout is a function g of Vₙ.

So if ƒ is such that

$$f ( {x}_{1} , {x}_{2} ) • g ( {x}_{2} - \frac{1}{n} {( {x}_{1} )}^{2} ) ,$$

in a frictionless market where the Xᵢ are independent is: Π_{0,n}(g(Vₙ))=B_{o,n}⁰E(ƒ(Mₙ¹,Mₙ²));

$$E ( f ( {M}_{n}^{1} , {M}_{n}^{2} ) ) = E ( {\int }_{- ∞}^{+ ∞} \tilde{f} ( {t}_{1} , {t}_{2} ) {e}^{2 iπ ( {t}_{1} {M}_{n}^{1} + {t}_{2} {M}_{n}^{2} )} d {t}_{1} d {t}_{2} ) ;$$

$$E ( f ( {M}_{n}^{1} , {M}_{n}^{2} ) ) = {\int }_{- ∞}^{+ ∞} \tilde{f} ( {t}_{1} , {t}_{2} ) E ( {e}^{2 iπ ( {t}_{1} {M}_{n}^{1} + {t}_{2} {M}_{n}^{2} )} ) d {t}_{1} d {t}_{2} ;$$

If the (Xᵢ)_{i=1, . . . ,n} are independent. With a BICs frame of mind with elicitation of summarizing variables, it is easy to see how to compute the conditional expectations iteratively backwards, yielding,

$$E ( f ( {M}_{n}^{1} , {M}_{n}^{2} ) ) = {\int }_{- ∞}^{+ ∞} {\int }_{- ∞}^{+ ∞} \tilde{f} ( {t}_{1} , {t}_{2} ) ( {\prod }_{k = 1}^{n} E ( h ( {X}_{k} , {t}_{1} , {t}_{2} ) ) ) d {t}_{1} d {t}_{2} ;$$

$$h ( {X}_{k} , {t}_{1} , {t}_{2} ) {•e}^{2 iπ ( {t}_{1} {X}_{k} + {t}_{2} {X}_{k}^{2} )} ;$$

$$h ( {X}_{k} , {t}_{1} , {t}_{2} ) = {\int }_{- ∞}^{+ ∞} \tilde{h} ( t , {t}_{1} , {t}_{2} ) {e}^{2 i π {tX}_{k}} d t ;$$

$$\tilde{h} ( t , {t}_{1} , {t}_{2} ) = {\int }_{- ∞}^{+ ∞} {e}^{2 i π {t}_{2} {x}^{2}} {e}^{- 2 i π ( t - {t}_{1} ) x} d x {=}^{Mathematica Formula} \frac{{e}^{- \frac{{iπ ( t - {t}_{1} )}^{2}}{2 {t}_{2}}}}{\sqrt{- 2 i {t}_{2}}} ;$$

$$E ( h ( {X}_{k} , {t}_{1} , {t}_{2} ) ) = {\int }_{- ∞}^{+ ∞} \tilde{h} ( t , {t}_{1} , {t}_{2} ) E ( {e}^{2 iπ {tX}_{k}} ) d t ;$$

$$If {X}_{k} is a Levy process , E ( {e}^{2 π i {tX}_{k}} ) = {e}^{Δ {t}_{k} {Ψ}_{k} ( 2 iπ t )} ;$$

$$E ( h ( {X}_{k} , {t}_{1} , {t}_{2} ) ) = {\int }_{- ∞}^{+ ∞} \frac{{e}^{- \frac{{iπ ( t - {t}_{1} )}^{2}}{2 {t}_{2}}} E ( {e}^{2 i π {tX}_{k}} )}{\sqrt{- 2 i {t}_{2}}} d t ;$$

$$E ( f ( {M}_{n}^{1} , {M}_{n}^{2} ) ) = {\int }_{- ∞}^{+ ∞} {\int }_{- ∞}^{+ ∞} \tilde{f} ( {t}_{1} , {t}_{2} ) ( {\prod }_{k = 1}^{n} ( {\int }_{- ∞}^{+ ∞} \frac{{e}^{- \frac{{iπ ( t - {t}_{1} )}^{2}}{2 {t}_{2}}} E ( {e}^{2 i π {tX}_{k}} )}{\sqrt{- 2 i {t}_{2}}} d t ) ) d {t}_{1} d {t}_{2} ;$$

If time increments are equal (Δtₖ=Δt) and the laws are identical (Xₖ≡X),

$$E ( f ( {M}_{n}^{1} , {M}_{n}^{2} ) ) = {\int }_{- ∞}^{- ∞} {\int }_{- ∞}^{+ ∞} \tilde{f} ( {t}_{1} , {t}_{2} ) {( {\int }_{- ∞}^{+ ∞} \frac{{e}^{- \frac{i {π ( t - {t}_{1} )}^{2}}{2 {t}_{2}}} E ( {e}^{2 i π tX} )}{\sqrt{- 2 i {t}_{2}}} d t )}^{n} d {t}_{1} d {t}_{2}$$

$${\prod }_{0 , n} ( g ( {V}_{n} ) ) = {B}_{o , n}^{0} {\int }_{- ∞}^{+ ∞} {\int }_{- ∞}^{+ ∞} \tilde{f} ( {t}_{1} , {t}_{2} ) {( {\int }_{- ∞}^{+ ∞} \frac{{e}^{- \frac{i {π ( t - {t}_{1} )}^{2}}{2 {t}_{2}}} E ( {e}^{2 i π tX} )}{\sqrt{- 2 i {t}_{2}}} d t )}^{n} d {t}_{1} d {t}_{2} ;$$

### Illustration: Case of A Geometric Brownian Motion With Time Dependent Parameters

$${\prod }_{0 , n} ( g ( {V}_{n} ) ) = {B}_{o , n}^{0} {\int }_{- ∞}^{+ ∞} {\int }_{- ∞}^{+ ∞} \frac{\tilde{f} ( {t}_{1} , {t}_{2} )}{{( \sqrt{- 2 i {t}_{2}} )}^{n}} {\prod }_{k = 1}^{n} ( {\int }_{- ∞}^{+ ∞} {e}^{- \frac{i {π ( t - {t}_{1} )}^{2}}{2 {t}_{2}}} E ( {e}^{2 i π {tX}_{k}} ) d t ) d {t}_{1} d {t}_{2}$$

$$If {X}_{t} follows a normal law , \\ E ( {e}^{2 iπ {tX}_{k}} ) = {e}^{Δ {t}_{k} ( - 2 {π}^{2} {σ}^{2} {t}^{2} + 2 π i bt )} - \frac{i {π ( t - {t}_{1} )}^{2}}{2 {t}_{2}} + Δ {t}_{k} ( - 2 {π}^{2} {σ}^{2} {t}^{2} + 2 π i bt ) = - ( \frac{i π}{2 {t}_{2}} + 2 {π}^{2} {σ}^{2} Δ {t}_{k} ) {t}^{2} + 2 iπ ( b Δ {t}_{k} + \frac{{t}_{1}}{2 {t}_{2}} ) t - iπ \frac{{t}_{1}^{2}}{2 {t}_{2}} = {α}_{k} {t}^{2} + 2 {πiβ}_{k} t + {γ}_{k} , \\ with$$

$${α}_{k} = ( \frac{iπ}{2 {t}_{2}} + 2 {π}^{2} {σ}^{2} Δ {t}_{k} ) ; {β}_{k} = ( b Δ {t}_{k} + \frac{{t}_{1}}{2 {t}_{2}} ) ; {γ}_{k} = - iπ \frac{{t}_{1}^{2}}{2 {t}_{2}} ;$$

$${\int }_{- ∞}^{+ ∞} {e}^{{α}_{k} {t}^{2} + 2 πi {β}_{k} t + {γ}_{k}} d t = {e}^{{γ}_{k}} {\int }_{- ∞}^{+ ∞} {e}^{{α}_{k} {t}^{2} + 2 πi {β}_{k} t} d t = \sqrt{\frac{π}{- {α}_{k}}} {e}^{\frac{{π}^{2} {β}_{k}^{2}}{{α}_{k}} + {γ}_{k}} ;$$

$${\prod }_{k = 1}^{n} ( {\int }_{- ∞}^{+ ∞} {e}^{- \frac{{iπ ( t - {t}_{1} )}^{2}}{2 {t}_{2}} + Δ {t}_{k} {Ψ}_{k} ( 2 iπ t )} d t ) = {\prod }_{k = 1}^{n} ( \sqrt{\frac{π}{- {α}_{k}}} {e}^{\frac{{π}^{2} {β}_{k}^{2}}{{α}_{k}} + {γ}_{k}} )$$

$${\prod }_{0 , n} ( g ( {V}_{n} ) ) = {B}_{o , n}^{0} {\int }_{- ∞}^{+ ∞} {\int }_{- ∞}^{+ ∞} \tilde{f} ( {t}_{1} , {t}_{2} ) \frac{{( \frac{π}{- 2 i {t}_{2}} )}^{n / 2}}{\sqrt{{( - 1 )}^{n} {\prod }_{k = 1}^{n} {α}_{k}}} {e}^{- i n π \frac{{t}_{1}^{2}}{2 {t}_{2}}}$$

$${e}^{{π}^{2} {\sum }_{k = 1}^{n} \frac{{β}_{k}^{2}}{{α}_{k}}} d {t}_{1} d {t}_{2}$$

$${α}_{k} = ( \frac{iπ}{2 {t}_{2}} + 2 {π}^{2} {σ}_{k}^{2} Δ {t}_{k} ) ; {β}_{k} = ( b Δ {t}_{k} + \frac{{t}_{1}}{2 {t}_{2}} ) ;$$

### Remark 1

### (i) Case of BICs Pricing Information In the Options Format

When computing E(h(Xₖ,t₁t₂)), we do not always have to the Fourier Transform of the density. Indeed, the BICs pricing information may often be provided in the options format. We would handle this case for instance as

$$E ( {e}_{2}^{2 iπ ( {t}_{1} {X}_{k} + {t}_{2} {X}_{k}^{2} )} ) = {\int }_{- ∞}^{+ ∞} {e}^{2 iπ ( {t}_{1} x + {t}_{2} {x}^{2} )} {p}_{Δ {t}_{k}}^{{X}_{k}} ( x ) d x$$

$${p}_{Δ {t}_{k}}^{{S}_{k}} ( {S}_{k} = s ) ds = {p}_{Δ {t}_{k}}^{{S}_{k}} ( {e}^{{X}_{k}} = {e}^{x} ) {e}^{x} dx = {p}_{Δ {t}_{k}}^{{X}_{k}} ( {X}_{k} = x ) dx$$

$${p}_{Δ {t}_{k}}^{{X}_{k}} ( {X}_{k} = x ) = {p}_{Δ {t}_{k}}^{{S}_{k}} ( {S}_{k} = {e}^{x} ) {e}^{x} = \frac{1}{{B}_{{t}_{k - 1} , {t}_{k}}^{0}} \frac{{\partial }^{2} {C}_{{t}_{k - 1} , {t}_{k}}^{0}}{{dK}^{2}} ( {e}^{x} ) {e}^{x} ;$$

$$x = Log [ s ] , dx = \frac{ds}{s} \\ {B}_{{t}_{k - 1} , {t}_{k}}^{0} E ( {e}^{2 iπ ( {t}_{1} {X}_{k} + {t}_{2} {X}_{k}^{2} )} ) = {\int }_{- ∞}^{+ ∞} {e}^{2 iπ ( {t}_{1} x + {t}_{2} {x}^{2} )} \frac{{\partial }^{2} {C}_{{t}_{k - 1} , {t}_{k}}^{0}}{d {K}^{2}} ( {e}^{x} ) {e}^{x} d x$$

(ii) Fourier Transform in Mathematica®

□ FourierTransform[expr, t, ω] gives the symbolic Fourier transform of expr.

The Fourier transform of a function f(t) is by default defined to be

$$\frac{1}{\sqrt{2 π}} {\int }_{- ∞}^{∞} f ( t ) {e}^{i ω t} d t$$

For example,

$$FourierTransform [ Exp [ 2 * j * Pi * x ⋀ 2 ] , x , 2 * Pi * k ] = \frac{{e}^{\frac{{k}^{2} π}{2 j}}}{2 \sqrt{- j} \sqrt{π}}$$

□ FourierTransform[expr, {t₁, t₂, . . . }, {ω₁, ω₂, . . . }] gives the multidimensional Fourier transform of expr.

### 3.2.3.3—General Moments Derivatives Pricing

It is now trivial to see that more generally, if we wish to price a moments based derivatives contract that depends on the statistical moments of the underlyings up to the moment of p-th order, the pricing formula can be obtained as

$${m}_{n}^{p} = {m}_{n}^{p} ( {M}_{n}^{1} , … , {M}_{n}^{p} ) ;$$

$$f ( {x}_{1} , … , {x}_{p} ) • g ( {m}_{n}^{p} ( {x}_{1} , … , {x}_{p} ) ) ;$$

$$\tilde{f} ( {t}_{1} , … , {t}_{p} ) = {\int }_{- ∞}^{+ ∞} … {\int }_{- ∞}^{+ ∞} f ( {x}_{1} , … , {x}_{p} ) {e}^{- 2 i π ( {t}_{1} {x}_{1} + … + {t}_{p} {x}_{p} )} d {x}_{1} … d {x}_{p} ;$$

$$h ( {X}_{k} , {t}_{1} , … , {t}_{p} ) • {e}^{2 iπ ( {\sum }_{j = 1}^{p} {{t}_{j} ( {X}_{k} )}^{j} )} ;$$

$$\tilde{h} ( t , {t}_{1} , … , {t}_{p} ) = {\int }_{- ∞}^{+ ∞} {e}^{2 iπ ( {\sum }_{j = 2}^{p} {{t}_{j} ( {X}_{k} )}^{j} )} {e}^{- 2 iπ ( t - {t}_{1} ) x} d x$$

$$E ( h ( {X}_{k} , {t}_{1} , … , {t}_{p} ) ) = {\int }_{- ∞}^{+ ∞} \tilde{h} ( t , {t}_{1} , … , {t}_{p} ) E ( {e}^{2 iπ {tX}_{k}} ) d t ;$$

As the Xₖ are independent,

$$E ( f ( {M}_{n}^{1} , … , {M}_{n}^{p} ) ) = {\int }_{- ∞}^{+ ∞} … {\int }_{- ∞}^{+ ∞} \tilde{f} ( {t}_{1} , … , {t}_{p} ) ( {\prod }_{k = 1}^{n} ( {\int }_{- ∞}^{+ ∞} \tilde{h} ( t , {t}_{1} , … , {t}_{p} ) E ( {e}^{2 iπ {tX}_{k}} ) d t ) ) d {t}_{1} … d {t}_{p} ;$$

If time increments are equal (Δtₖ=Δt) and the laws are identical (Xₖ≡X),

$$E ( f ( {M}_{n}^{1} , … , {M}_{n}^{p} ) ) = {\int }_{- ∞}^{+ ∞} … {\int }_{- ∞}^{+ ∞} \tilde{f} ( {t}_{1} , … , {t}_{p} ) {( {\int }_{- ∞}^{+ ∞} \tilde{h} ( t , {t}_{1} , … , {t}_{p} ) E ( {e}^{2 iπ tX} ) d t )}^{n} d {t}_{1} … d {t}_{p}$$

$${\prod }_{0 , n} ( g ( {m}_{n}^{p} ) ) = {B}_{o , n}^{0} {\int }_{- ∞}^{+ ∞} … {\int }_{- ∞}^{+ ∞} \tilde{f} ( {t}_{1} , … , {t}_{p} ) {( {\int }_{- ∞}^{+ ∞} \tilde{h} ( t , {t}_{1} , … , {t}_{p} ) E ( {e}^{2 iπ tX} ) d t )}^{n} d {t}_{1} … d {t}_{p} ;$$

It is very clear that if mₙ^{p} is merely a linear function of Mₙ¹, . . . , Mₙ^{p}, the integrations on □^{p} can be further shrunk into integrals on □.

The states span for higher order moments can also be readily guessed on the model of states span for the first two moments. This example decisively illustrates how the broad BICs argument on principle is applied to a very current and practical quantitative finance research issue with measurable edge.

It becomes easier to guess the pricing algorithms and the optimized forms of the various derivatives contracts that will be reviewed in Volume II, the Asian Options case below is further illustrative

### 3.2. 4. Asian Options Derivatives Pricing

$$f ( {Z}_{n} ) = {\int }_{- ∞}^{+ ∞} \tilde{f} ( t ) {e}^{2 iπ {tZ}_{n}} d t ;$$

$$with \tilde{f} ( t ) = {\int }_{- ∞}^{+ ∞} f ( x ) {e}^{- 2 i π tx} d x ;$$

$${Z}_{n} = {\sum }_{k = 0}^{n} {α}_{k} {S}_{k} ; 1 \leq k , \\ {S}_{k} = {S}_{0} {e}^{{\sum }_{i = 1}^{k} Log [ \frac{{S}_{i}}{{S}_{i - 1}} ] } • {S}_{0} {e}^{{\sum }_{i = 1}^{k} {X}_{i}} ;$$

$${Z}_{n} = {S}_{0} ( {α}_{0} + {e}^{{X}_{1}} ( {α}_{1} + {e}^{{X}_{2}} ( {α}_{2} + {e}^{{X}_{3}} ( {α}_{3} + … {e}^{{X}_{n - 1}} ( {α}_{n - 1} + {α}_{n} {e}^{{X}_{n}} ) ) ) ) )$$

$${e}^{2 iπ {tZ}_{n}} = {\prod }_{k = 0}^{n} {e}^{2 iπ t {α}_{k} {S}_{0} {\prod }_{i = 1}^{k} {e}^{{X}_{i}}} = {\prod }_{k = 0}^{n} {e}^{2 iπ t {α}_{k} {S}_{0} {e}^{( n - k + 1 ) {X}_{k}}}$$

$$Since , the {( {X}_{k} )}_{0 \leq k \leq n} are independent , {X}_{0} ≡ 0 , \\ E ( {e}^{2 i π {tZ}_{n}} ) = {e}^{2 i π t {α}_{0} {S}_{0}} {\prod }_{k = 1}^{n} E ( {e}^{2 i π t {α}_{k} {S}_{0} {e}^{( n - k + 1 ) {X}_{k}}} )$$

$${e}^{2 i π t {α}_{k} {S}_{0} {e}^{( n - k + 1 ) {X}_{k}}} = {\int }_{- ∞}^{+ ∞} {h}_{k} ( s ) {e}^{2 i π {sX}_{k}} d s ;$$

$${h}_{a , b} ( k ) = {\int }_{- ∞}^{+ ∞} {e}^{2 b {πe}^{ax}} {e}^{2 iπ kx} d x = - \frac{{( - 2 π b )}^{\frac{2 i k π}{a}}}{a} Γ ( \frac{2 i k π}{a} )$$

$${h}_{k} ( s ) = {\int }_{- ∞}^{+ ∞} {e}^{2 iπ t {α}_{k} {S}_{0} {e}^{( n - k + 1 ) x}} {e}^{- 2 i π sx} d x = {h}_{( n - k + 1 ) , it {α}_{k} {S}_{0}} ( - S ) = \frac{{( - 2 π i t {α}_{k} {S}_{0} )}^{\frac{- 2 is π}{( n - k + 1 )}}}{( n - k + 1 )} Γ ( \frac{- 2 i s π}{( n - k + 1 )} )$$

$$E ( {e}^{2 i πt {α}_{k} {S}_{0} {e}^{( n - k + 1 ) {X}_{k}}} ) = {\int }_{- ∞}^{+ ∞} {h}_{k} ( s ) E ( {e}^{2 i π {sX}_{k}} ) d s$$

$$E ( {e}^{2 iπ t {α}_{k} {S}_{0} {e}^{( n - k + 1 ) {X}_{k}}} ) = {\int }_{- ∞}^{+ ∞} \frac{{( - 2 πi t {α}_{k} {S}_{0} )}^{\frac{- 2 is π}{( n - k + 1 )}}}{( n - k + 1 )} Γ ( \frac{- 2 i s π}{( n - k + 1 )} ) E ( {e}^{2 i π {sX}_{k}} ) d s$$

$$f ( {Z}_{n} ) = {\int }_{- ∞}^{+ ∞} \tilde{f} ( t ) {e}^{2 iπ {tZ}_{n}} d t$$

$$E ( {e}^{2 iπ {tZ}_{n}} ) = {e}^{2 iπ t {α}_{0} {S}_{0}} {\prod }_{k = 1}^{n} E ( {e}^{2 iπ t {α}_{k} {S}_{0} {e}^{( n - k + 1 ) {X}_{k}}} )$$

$$E ( f ( {Z}_{n} ) ) = {\int }_{- ∞}^{+ ∞} \tilde{f} ( t ) {e}^{2 i π t {α}_{0} {S}_{0}} {\prod }_{k = 1}^{n} ( {\int }_{- ∞}^{+ ∞} \frac{{( - 2 π i t {α}_{k} {S}_{0} )}^{\frac{- 2 is π}{( n - k + 1 )}}}{( n - k + 1 )} Γ ( \frac{- 2 i s π}{( n - k + 1 )} ) E ( {e}^{2 i π s {X}_{k}} ) d s ) d t$$

Depending on the specification of Ψₖ the integral

$${\int }_{- ∞}^{+ ∞} \frac{{( - 2 π it {α}_{k} {S}_{0} )}^{\frac{- 2 i s π}{( n - k + 1 )}}}{( n - k + 1 )} Γ ( \frac{- 2 i s π}{( n - k + 1 )} ) E ( {e}^{2 i π {sX}_{k}} ) d s$$

may actually be analytically computable with a closed form.

The price of the Asian derivatives contract hence becomes

$${Π}_{0 , n} ( f ( {Z}_{n} ) ) = {B}_{o , n}^{0} \times {\int }_{- ∞}^{+ ∞} \tilde{f} ( t ) {e}^{2 i π t {α}_{0} {S}_{0}} {\prod }_{k = 1}^{n} ( {\int }_{- ∞}^{+ ∞} \frac{{( - 2 π it {α}_{k} {S}_{0} )}^{\frac{- 2 i s π}{( n - k + 1 )}}}{( n - k + 1 )} Γ ( \frac{- 2 i s π}{( n - k + 1 )} ) E ( {e}^{2 i π {sX}_{k}} ) d s ) d t$$

### Remark

### (i) A Few Examples of Relevant Functions f And Their Fourier Transforms

For Asian Derivatives

$$f ( x ) = Max ( x , 0 ) ;$$

$$\tilde{f} ( k ) = {\int }_{- ∞}^{+ ∞} f ( t ) {e}^{- 2 i π kt} d t = - \frac{1}{4 {π}^{2} {k}^{2}} ;$$

$$f ( x ) = Min ( x , 0 ) ;$$

$$\tilde{f} ( k ) = {\int }_{- ∞}^{+ ∞} f ( t ) {e}^{- 2 i π kt} d t = \frac{1}{4 {π}^{2} {k}^{2}} ;$$

For Volatility Derivatives

$$f ( x ) = Max ( \sqrt{x} - a , 0 ) ;$$

$$\tilde{f} ( k ) = - \frac{1}{120 k π k {\vert k \vert}^{3 / 2}}$$

$$( i ( \begin{matrix}- 15 k ( i + Sign ( k ) ) \\ + 4 a {\vert k \vert}^{3 / 2} ( \begin{matrix}15 + ( \begin{matrix}- 20 {ia}^{2} k π HypergeometricPFQ [ \{ \frac{3}{4} \} , \{ \frac{1}{2} , \frac{7}{4} \} , - {a}^{4} {k}^{2} {π}^{2} ] \\ + 3 ( \begin{matrix}- 5 + 5 Cos ( 2 {a}^{2} k π ) \\ + 8 {a}^{4} {k}^{2} {π}^{2} HypergeometricPFQ [ \{ \frac{5}{4} \} , \{ \frac{3}{2} , \frac{9}{4} \} , - {a}^{4} {k}^{2} {π}^{2} ] \\ + 5 i Sin ( 2 {a}^{2} k π )\end{matrix} )\end{matrix} ) \times \\ UnitStep [ a ]\end{matrix} )\end{matrix} ) ) ;$$

$$f ( x ) = Min ( \sqrt{x} - a , 0 ) ;$$

$$\tilde{f} ( k ) = ( 2 ia \sqrt{k} - i \times FresnelC [ 2 a \sqrt{k} ] + FresnelS [ 2 a \sqrt{k} ] ) \times \frac{( - 1 + UnitStep [ - a ] )}{4 π {k}^{3 / 2}} ;$$

with the following notations

HypergeometricPFQ[{a₁, . . . , aₚ}, {b₁, . . . , b_{q}}, z] is the generalized hypergeometric function p^{F}q^{(a;b;z)}

p^{F}q^{(a; b; z)} has series expansion

$${\sum }_{k = 0}^{∞} {( {a}_{1} )}_{k} … {( {a}_{p} )}_{k} / {( {b}_{1} )}_{k} … {( {b}_{q} )}_{k} {z}^{k} / k ! .$$

FresnelC[z] gives the Fresnel integral C(z) and is given by ∫₀^{z}cos(πt²/2)dt

FresnelS[z] gives the Fresnel integral S(z) and is given by ∫₀^{z}cos(πt²/2)dt

UnitStep[x] represents the unit step function, equal to 0 for x<0 and 1 for x□0.

These functions are all predefined in many scientific software packages, for instance Mathematica® whose notation is adopted here.

### (ii) How the Products of Integrals Inside the Integral Help Reduce the Dimension of Integrals

Each integral is a function g of t and k. We represent g in a desirable functional basis such as the Fourier basis or a polynomial basis. Computing each term in the Fourier basis for instance is a triple integral. With the Taylor decomposition in a polynomial basis, we may need to perform derivations. In each case, we may need to actually compute only a handful of those.

The use of the Fourier Basis here is not restrictive but merely an appropriate illustration that fits well with the use of Levy processes to model the dynamic of underlyings and the ready availability of tools to speed computations such as the Fast Fourier Transform.

Indeed the general projection procedure works for any selected basis in a quadratic approximation representation. As such using the generic result, and having pre-computed the aᵢⱼ once the basis of fⱼ, is selected, we simply need to compute the coefficients

$${b}_{j} = {\int }_{Δ} {f}_{j} ( X ) f ( X ) d μ ( X ) .$$

As said earlier usually the functions constitute a Hilbert Basis so that the matrix A is the identity, simplifying computations. In the engineering sciences, the other basis to have been successful in this type of endeavor, is the family of wavelets.

### (iii) How to Compute the Integrals In General

In General the integrals would be computed by resealing the real set into a open set whose closure is an interval. If one is inclined to use the residue theorem, it is important to ensure that the integrand with the variables extended to the complex set is a meromorphic function. As dimensions grow, low discrepancy sequences such as those reviewed in chapter XII of the Book BICs 4 Derivatives Volume I may come into play.

### 3.3. The Law of the Few In Other Derivatives Pricing Innovations

Current simplifying methods for derivatives pricing can be viewed as possibly unconscious mere applications of the Law of the Few. This can be seen in the major numerical methods for derivatives pricing currently in use, PDEs, Monte Carlo and Trees.

### 3.3.1. PDEs: Galerkin Methods

The projection method as described here provides benefits similar to Galerkin methods used in the resolution of Partial Differential Equations (PDE), arguably in our use from amore general and easier to implement perspective, and thus help very effectively counter some of the benefits that could be claimed in a numerical resolution of PDEs.

The essence of the Galerkin methods is as follows. Suppose we have a problem of the form: Lu=f where L is a linear operator, f is a given function, u is an unknown function. One tries to solve u by selecting a set of basis functions u₁, . . ., uₙ and try to find the best approximation of the solution to the equation that is a combination of the basis functions,
The goal is to find

$${Arg Min}_{{α}_{i} , i = 1 , … , n} {‖ {\sum }_{i = 1}^{n} {α}_{i} {Lu}_{i} - f ‖}_{2}^{2} .$$

We note:

$${a}_{i , j} = < {u}_{i} , {Lu}_{j} > ;$$

$$A = {( {a}_{i , j} )}_{i , j} ;$$

$${b}_{i} = < {u}_{i} , f > ;$$

$$B = {( {b}_{i} )}_{i} ;$$

$${α}_{i} = < {u}_{i} , f > ;$$

If A is symmetric inversible,

$${Arg Min}_{{α}_{i} , i = 1 , … , n} {‖ {\sum }_{i = 1}^{n} {α}_{i} {Lu}_{i} - f ‖}_{2}^{2} = {A}^{- 1} B ;$$

i.e.:

### 3.3.2. Monte Carlo

The state of the art propose a least square regression method on certain polynomial functions for pricing American options in a Monte Carlo simulation framework which can be related to the projection approach described here. State of the art tests indicate that the method is robust to the choice of alternative polynomial choices and require very few polynomials.

### 3.3.3. Trees

Readers familiar with binomial or trinomial pricing methods are well aware that with non-recombining trees, the number of nodes grows exponentially with the number of time steps. That is if at step 1 we have two nodes, at step 2 we have 22=4 nodes, at step n we have 2n nodes. In practice one uses the recombination assumption in trees that reflects Markov assumptions on the dynamic of the underlying. This allows the size of trees to grow linearly. The Markov assumption can be viewed here as an illustration of the law of the few where a dependence on several underlyings is reduced to a single underlying. In subsequent recent uses of trees to price path dependent options, the sate of the art proposes a path bundling method in the pricing of Asian options. Such a method can be related to the change of variable approaches.

### 4. Conclusion

The perspective provided here is not meant to be exhaustive but to help the interested reader now more easily identify numerous other instances where this law is at play, facilitating the practical resolution of the problems under investigation.

In any case, we have shown here how the BICs analysis, for its practical use, relies on this general law or principle to become an operational and practical tool of derivatives analysis.

All patents cited in this application are hereby included by reference. While the present invention has been described in connection with preferred embodiments, it is not intended to limit the scope of the invention to the particular form set forth, but, on the contrary, it is intended to cover such alternatives, modifications, equivalents as may be included within the spirit and scope of the invention defined in the appended claims.

1. A method for generating the multivariate distribution of two of more underlyings as an intermediate step in making decisions involving two or more unknown factors, said method comprising
a) receiving a complete set of BICs prices for each possible fixed and limited number individual underlying(s) in any admissible BICs payout format
b) Transforming said BICs prices into univariate, bivariate or BICs prices for at most the given fixed number of underlyings in a target BICs payout format
c) Receiving parametric analytic formulas for BICs prices in the target BICs payout format.
d) Receiving effective inverse methods or algorithms to generate the corresponding implied parameters functions
e) Generating the implied parametric functions by taking each time the BICs price corresponding to each state variable spanned and using the inverse method or algorithm of step d) to generate the corresponding implied parameter(s)
f) Inputting those implied parameters into the formula that uses them to yield the multivariate density function

2. The method of claim 1, where
a) The target BICs payout format of steps b) and c) is the Options format
b) The analytic formulas of step c) are computed under the Black-Scholes Merton original assumptions of lack of frictions and Geometric Brownian motion distribution of underlyings
c) The implied parameters of steps e) and f) are implied volatilities or implied volatilities and implied correlations

3. A method for generating effective implied correlations, said method recovering the implied correlation function by inversion of the bivariate BICs prices in the option format.

4. A Method for efficiently and flexibly generating the price of a target derivatives contract using the repetitiveness of BICs prices in the BICs backward iterative pricing sequence, said method comprising:
a) Selecting a set of encapsulating variables that exactly or acceptably approximate the information content of the variables upon which the payout or the BICs prices depend while breaking the exponential growth of the content of those variables with time to at most a few computationally tractable dimensions.
b) Performing the BICs iterative pricing algorithm analytically to obtain the target derivatives contract price as an integral of dimension equal to the number of future trading periods
c) Reducing the dimension of the integral of step b) to a few computationally tractable dimensions by isolating the similitude of BICs analytic pricing formulas over incremental time steps
d) Obtaining the target derivatives contract exact or approximate analytic pricing formula as an integral of at most a few dimensions.

5. The method of claim 4 where the target derivatives contract reduces to a function of the realized moments of the underlyings

6. The method of claim 5 where the moments are first or second order moments

7. The method of claim 5 where the moments are first to fourth order moments

8. The method of claim 4 where the variations of the underlying(s) is (are) independent

9. The method of claim 4 where the variations of the underlying(s) is (are) independent and identically distributed or the underlying(s) is (are) driven by a levy process.
